(19) United States
(12) Patent Application Publication
(10) Pub. No.: US 2025/0291641 A1
(43) Pub. Date: Sep. 18, 2025

(54) Dynamic Budgeting for Computing Devices and Computing Infrastructure

(71) Applicant: Oracle International Corporation, Redwood Shores, CA (US)

(72) Inventors: Jonathan Luke Herman, Seattle, WA (US); Nathaniel Alexander Jones, Lexington, KY (US); Sumeet Kochar, Cary, NC (US); Jeffrey Francis Phillips, Lexington, KY (US); Joshua Potter, Rogersville, TN (US); Justin D. Proffitt, La Grange, KY (US); Erik Paul Reiter, Amelia, OH (US); Yuxin Zhong, Kenmore, WA (US)

(73) Assignee: Oracle International Corporation, Redwood Shores, CA (US)

(21) Appl. No.: 19/072,426

(22) Filed: Mar. 6, 2025

Related U.S. Application Data
(60) Provisional application No. 63/565,745, filed on Mar. 15, 2024.
(60) Provisional application No. 63/565,755, filed on Mar. 15, 2024.

(51) Int. Cl. G06F 9/50

(52) U.S. Cl. CPC G06F 9/5061; G06F 9/5094

(57) ABSTRACT

Techniques are disclosed for dynamically updating budgeting for utilization of resources. The system monitors the operating conditions of a network of devices that impact resource utilization by the network of devices, and the system determines actual or predicted changes in the operating conditions. For instance, the system may determine or predict changes to a topology of the network of devices, the state of individual devices in the network of devices, external limitations imposed on the network of devices, atmospheric conditions in an environment including the network of devices, changes to devices not represented in the topology of the network of devices, and other operating conditions of the network of devices. Responsive to determining an actual or predicted change in operating conditions, the system may update budgeting for the network of devices by generating updated budgets for one or more devices included in the network of devices.

### INCORPORATION BY REFERENCE; DISCLAIMER

Each of the following applications are hereby incorporated by reference: Application No. 63/565,745, filed on Mar. 15, 2024; Application No. 63/565,755 filed on Mar. 15, 2024. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to generating budgets for devices. In particular, the present disclosure relates to generating budgets for devices that perform and/or facilitate computing operations.

### BACKGROUND

The term “data center” refers to a facility that includes one or more computing devices that are dedicated to processing, storing, and/or delivering data. A data center may be a stationary data center (e.g., a dedicated facility or a dedicated room of a facility) or a mobile data center (e.g., a containerized data center). A data center may be an enterprise data center, a colocation data center, a cloud data center, an edge data center, a hyperscale data center, a micro data center, a telecom data center, and/or another variety of data center. A data center may be a submerged data center, such as an underground data center or an underwater data center. A data center may include a variety of hardware devices, software devices, and/or devices that include both hardware and software. General examples of devices that may be included in a data center include compute devices, virtual devices, power infrastructure devices, network infrastructure devices, atmospheric regulation devices, security devices, monitoring and management devices, and other devices that support the operation of a data center. A data center may utilize a variety of resources, such as energy resources (e.g., electricity, coolant, fuel, etc.), compute resources (e.g., processing resources, memory resources, network resources, etc.), capital resources (e.g., cash spent on electricity, coolant, fuel, etc.), administrative resources (carbon credits, emission allowances, renewable energy credits, etc.), and/or other types of resources.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment, and they mean at least one. In the drawings:

FIGS. 1-4 are block diagrams illustrating patterns for implementing a cloud infrastructure as a service system in accordance with one or more embodiments;

FIG. 5 is a hardware system in accordance with one or more embodiments;

FIG. 6 illustrates a machine learning engine in accordance with one or more embodiments;

FIG. 7 illustrates an example set of operations that may be performed by a machine learning engine in accordance with one or more embodiments;

FIG. 8 illustrates a resource management system in accordance with one or more embodiments;

FIG. 9 illustrates an example set of operations for dynamic budgeting in accordance with one or more embodiments; and

FIG. 10 illustrates a topology of a simplified example of a data center in accordance with an example embodiment.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The following table of contents is provided for the reader's convenience and is not intended to define the limits of the disclosure.
1. GENERAL OVERVIEW
2. CLOUD COMPUTING TECHNOLOGY
3. COMPUTER SYSTEM
4. MACHINE LEARNING ARCHITECTURE
5. RESOURCE MANAGEMENT SYSTEM
6. DYNAMIC BUDGETING
7. EXAMPLE EMBODIMENT
8. MISCELLANEOUS; EXTENSIONS

### 1. General Overview

One or more embodiments (a) monitor the operating conditions of a data center, (b) determine an actual or predicted change to the operating conditions of the data center, and (c) dynamically update budgeting for the data center to account for the actual or predicted change to the operating conditions of the data center. The system updates budgeting for the data center by determining updated budgets for individual devices in the data center. As used herein, the term “budget” refers to one or more defined allocations of resources. Example resources that may be allocated by a budget include energy resources, computer resources, capital resources, administrative resources, and other types of resources. As used herein, the term “operating condition” refers to information that is relevant to budgeting the utilization of a resource. Example operating conditions of the data center that may be monitored by the system include topological characteristics of the data center, characteristics of devices included in the data center, external limitations imposed on the data center, atmospheric conditions inside of the data center, atmospheric conditions outside of the data center, resource consumption of devices not represented in a topology of the data center, and other information. As used herein, the term “topology” refers to a set of one or more topological characteristics of a network of devices.

One or more embodiments (a) monitor the operating conditions of a data center (e.g., topological characteristics of the data center), (b) dynamically update a topology of the data center to reflect changes to topological characteristics of the data center, and (c) dynamically update individual budgets of individual devices represented in the topology of the data center to reflect changes to the operating conditions of the data center. The topology of the data center illustrates a hierarchy of parent-child relationships between the devices in the data center. As used herein, the term “child device” refers to a device that (a) is distributed resources from another device and/or (b) is a subcomponent of the other device. For example, a host is a child device of a rack of hosts that includes the host because (a) the rack of hosts may include a rack power distribution unit that distributes electricity to the host and/or (b) the host is a subcomponent of the rack of hosts. Conversely, a device is referred to herein as a “parent device” if that device (a) distributes resources to another device and/or (b) includes the other device as a subcomponent. For example, a rack of hosts is a parent device to a host included in the rack of hosts. An example topology of the data center maps an electricity distribution network that supports the operation of compute devices in the data center. As used herein, the term “compute device” refers to a device that provides computer resources (e.g., processing resources, memory resources, network resources, etc.) for computing activities (e.g., computing activities of data center users). A host (e.g., CPU servers, GPU chassis, etc.) is one example of a compute device. The budgeting for the data center includes individual budgets for parent devices represented in the example topology of the data center, and the budgeting for the data center includes individual budgets for child devices represented in the example topology of the data center.

One or more embodiments (a) monitor the operating conditions of a data center, (b) determine an actual or predicted change to the operating conditions of the data center, and (c) update budgeting in the data center to restrict the power draw of individual devices in the data center in response to the actual or predicted change to the operating conditions of the data center. The system updates budgeting for the data center reactively. For example, if the system observes that a temperature inside of the data center has risen to a point that is outside of the data center's normal operating conditions, the system may update budgeting in the data center to reduce the power consumption of compute devices and thereby reduce the heat output of devices in the data center. Additionally, or alternatively, the system updates budgeting for the data center preemptively. In an example, the system predicts that a device in the data center will fail (e.g., a power infrastructure device, an atmospheric regulation device, a compute device, etc.), and the system updates budgeting for the data center in an attempt to prevent the failure and/or mitigate the impact of the failure when the failure occurs. For instance, if the device is an atmospheric regulation device that regulates temperature inside of the data center in this example, the system may update budgeting in the data center to reduce the power consumption of compute devices whose heat output is compensated for by the atmospheric regulation device. The system may apply a trained machine learning model to generate updated budgets for devices in the data center. Additionally, or alternatively, the system may apply a trained machine learning model to predict changes to operating conditions of the data center.

One or more embodiments described in this Specification and/or recited in the claims may not be included in this General Overview section.

### 2. Cloud Computing Technology

Infrastructure as a Service (IaaS) is an application of cloud computing technology. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components; example services include billing software, monitoring software, logging software, load balancing software, clustering software, etc. Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and install enterprise software into that VM. Customers can then use the provider's services to perform various functions, including balancing network traffic, troubleshooting application issues, monitoring performance, and managing disaster recovery, etc.

In some cases, a cloud computing model will involve the participation of a cloud provider. The cloud provider may, but need not, be a third-party service that specializes in providing (e.g., offering, renting, selling) IaaS. An entity may also opt to deploy a private cloud, becoming its own provider of infrastructure services.

In some examples, IaaS deployment is the process of implementing a new application, or a new version of an application, onto a prepared application server or other similar device. IaaS deployment may also include the process of preparing the server (e.g., installing libraries, daemons, etc.). The deployment process is often managed by the cloud provider below the hypervisor layer (e.g., the servers, storage, network hardware, and virtualization). Thus, the customer may be responsible for handling (OS), middleware, and/or application deployment, such as on self-service virtual machines. The self-service virtual machines can be spun up on demand.

In some examples, IaaS provisioning may refer to acquiring computers or virtual hosts for use, even installing needed libraries or services on them. In most cases, deployment does not include provisioning, and the provisioning may need to be performed first.

In some cases, there are challenges for IaaS provisioning. There is an initial challenge of provisioning the initial set of infrastructure. There is an additional challenge of evolving the existing infrastructure (e.g., adding new services, changing services, removing services, etc.) after the initial provisioning is completed. In some cases, these challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on one another, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up for one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). In some embodiments, infrastructure and resources may be provisioned (manually, and/or using a provisioning tool) prior to deployment of code to be executed on the infrastructure. However, in some examples, the infrastructure that will deploy the code may first be set up. In some instances, the provisioning can be done manually, a provisioning tool may be utilized to provision the resources, and/or deployment tools may be utilized to deploy the code once the infrastructure is provisioned.

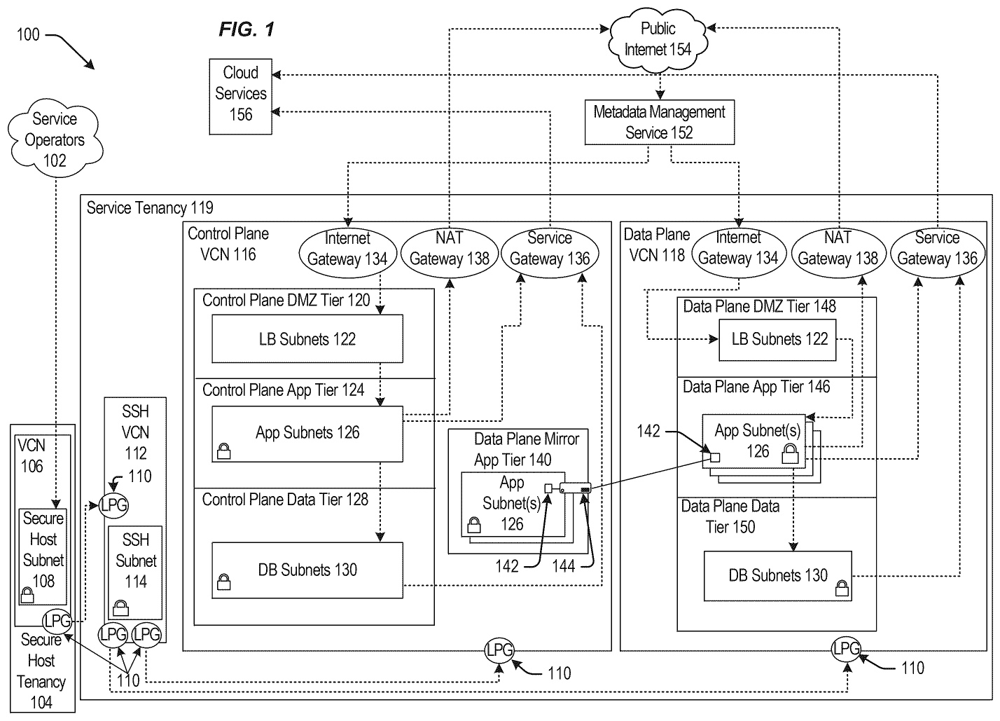

FIG. 1 is a block diagram illustrating an example pattern of an IaaS architecture 100 according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices, such as portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers, including personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems such as Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124 and an Internet gateway 134 that can be contained in the control plane VCN 116. The app subnet(s) 126 can be communicatively coupled to the DB subnet(s) 130 contained in the control plane data tier 128 and a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively coupled to cloud services 156.

In some examples, the service gateway 136 of the control plane VCN 116 or of the data plane VCN 118 can make application programming interface (API) calls to cloud services 156 without going through public Internet 154. The API calls to cloud services 156 from the service gateway 136 can be one-way; the service gateway 136 can make API calls to cloud services 156, and cloud services 156 can send requested data to the service gateway 136. However, cloud services 156 may not initiate API calls to the service gateway 136.

In some examples, the secure host tenancy 104 can be directly connected to the service tenancy 119. The service tenancy 119 may otherwise be isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118, and the data plane mirror app tier 140 of the control plane VCN 116 can communicate with the data plane app tier 146 of the data plane VCN 118 via VNICs 142 that can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configuration to, resources contained in the data plane VCN 118.

In some embodiments, the control plane VCN 116 and the data plane VCN 118 can be contained in the service tenancy 119. In this case, the user, or the customer, of the system may not own or operate either the control plane VCN 116 or the data plane VCN 118. Instead, the IaaS provider may own or operate the control plane VCN 116 and the data plane VCN 118. The control plane VCN 116 and the data plane VCN 118 may be contained in the service tenancy 119. This embodiment can enable isolation of networks that may prevent users or customers from interacting with other users', or other customers', resources. Also, this embodiment may allow users or customers of the system to store databases privately without needing to rely on public Internet 154 for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119. The service tenancy 119 may be isolated from public Internet 154.

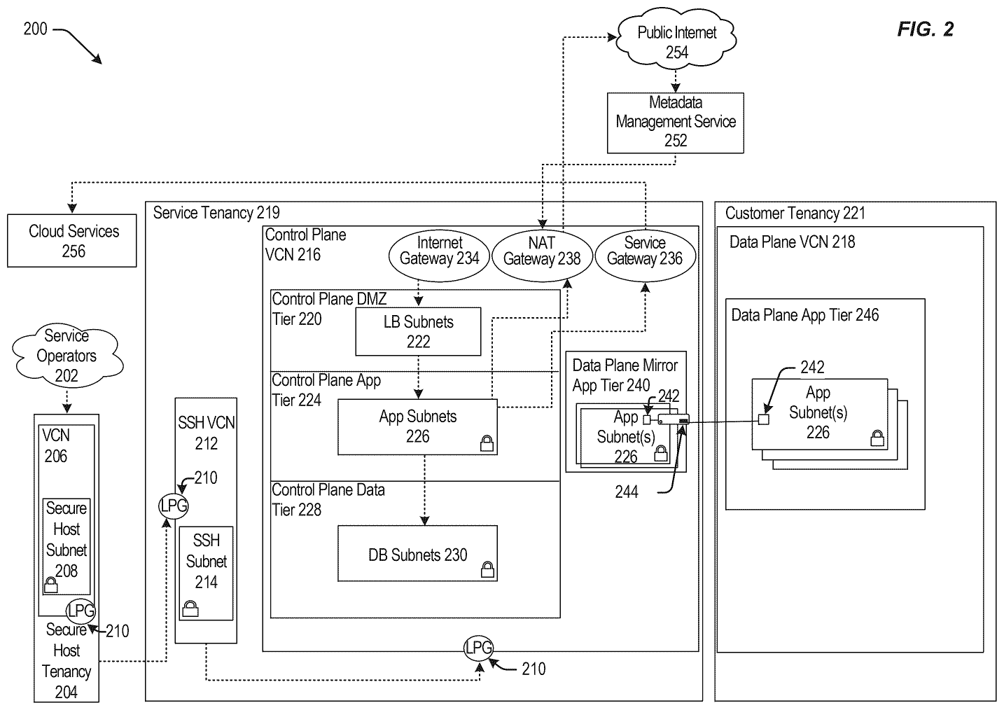

FIG. 2 is a block diagram illustrating another example pattern of an IaaS architecture 200 according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), and a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1) that can be contained in the control plane VCN 216. The app subnet(s) 226 can be communicatively coupled to the DB subnet(s) 230 contained in the control plane data tier 228 and a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively coupled to cloud services 256 (e.g., cloud services 156 of FIG. 1).

In some examples, the data plane VCN 218 can be contained in the customer tenancy 221. In this case, the IaaS provider may provide the control plane VCN 216 for each customer, and the IaaS provider may, for each customer, set up a unique, compute instance 244 that is contained in the service tenancy 219. Each compute instance 244 may allow communication between the control plane VCN 216 contained in the service tenancy 219 and the data plane VCN 218 that is contained in the customer tenancy 221. The compute instance 244 may allow resources provisioned in the control plane VCN 216 that is contained in the service tenancy 219 to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment or other usage of resources of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in “Region 1,” and cloud service “Deployment 1” may be located in Region 1 and in “Region 2.” If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

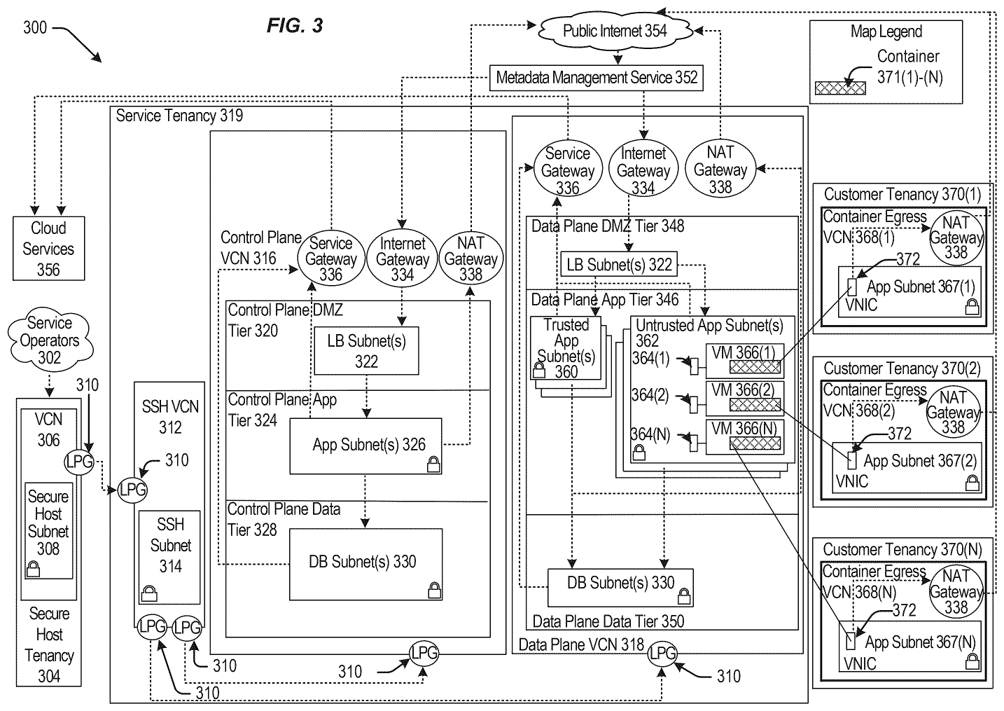

FIG. 3 is a block diagram illustrating another example pattern of an IaaS architecture 300 according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane VCN 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), and a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316, and the app subnet(s) 326 can be communicatively coupled to the DB subnet(s) 330 contained in the control plane data tier 328 and to a service gateway 336 (e.g., the service gateway of FIG. 1) and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360, untrusted app subnet(s) 362 of the data plane app tier 346, and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Each tenant VM 366(1)-(N) can be communicatively coupled to a respective app subnet 367(1)-(N) that can be contained in respective container egress VCNs 368(1)-(N) that can be contained in respective customer tenancies 380(1)-(N). Respective secondary VNICs 372(1)-(N) can facilitate communication between the untrusted app subnet(s) 362 contained in the data plane VCN 318 and the app subnet contained in the container egress VCNs 368(1)-(N). Each container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management service 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively coupled to cloud services 356.

In some embodiments, the data plane VCN 318 can be integrated with customer tenancies 380. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether or not to run code given to the IaaS provider by the customer.

In some examples, the customer of the IaaS provider may grant temporary network access to the IaaS provider and request a function to be attached to the data plane app tier 346. Code to run the function may be executed in the VMs 366(1)-(N), and the code may not be configured to run anywhere else on the data plane VCN 318. Each VM 366(1)-(N) may be connected to one customer tenancy 380. Respective containers 381(1)-(N) contained in the VMs 366(1)-(N) may be configured to run the code. In this case, there can be a dual isolation (e.g., the containers 381(1)-(N) running code), where the containers 381(1)-(N) may be contained in at least the VM 366(1)-(N) that are contained in the untrusted app subnet(s) 362) that may help prevent incorrect or otherwise undesirable code from damaging the network of the IaaS provider or from damaging a network of a different customer. The containers 381(1)-(N) may be communicatively coupled to the customer tenancy 380 and may be configured to transmit or receive data from the customer tenancy 380. The containers 381(1)-(N) may not be configured to transmit or receive data from any other entity in the data plane VCN 318. Upon completion of running the code, the IaaS provider may kill or otherwise dispose of the containers 381(1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 381(1)-(N) that can be contained in the VM 366(1)-(N) of each customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

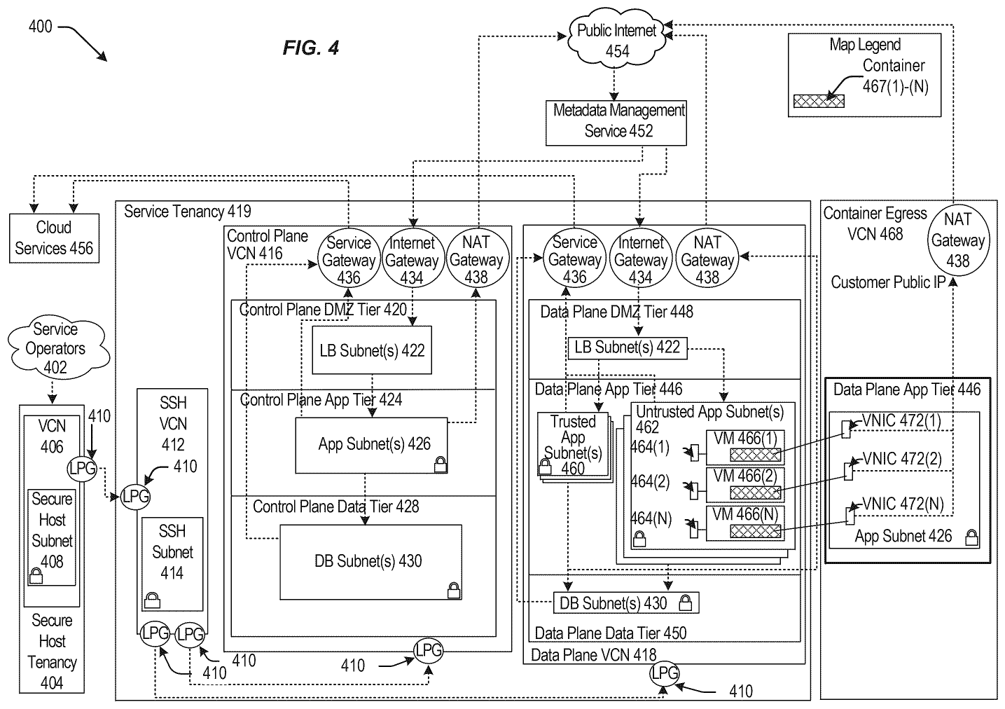

FIG. 4 is a block diagram illustrating another example pattern of an IaaS architecture 400 according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1), and the SSH VCN 412 can be communicatively coupled to a control plane VCN 416 (e.g., the control plane VCN 116 of FIG. 1) via an LPG 410 contained in the control plane VCN 416 and to a data plane VCN 418 (e.g., the data plane VCN 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), and a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424 and to an Internet gateway 434 (e.g., the Internet gateway 134 of FIG. 1) that can be contained in the control plane VCN 416, and the app subnet(s) 426 can be communicatively coupled to the DB subnet(s) 430 contained in the control plane data tier 428 and to a service gateway 436 (e.g., the service gateway of FIG. 1) and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Each tenant VM 466(1)-(N) can run code in a respective container 467(1)-(N) and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management service 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively coupled to cloud services 456.

In some examples, the pattern illustrated by the architecture of block diagram 400 of FIG. 4 may be considered an exception to the pattern illustrated by the architecture of block diagram 300 of FIG. 3 and may be desirable for a customer of the IaaS provider if the IaaS provider cannot directly communicate with the customer (e.g., a disconnected region). The respective containers 467(1)-(N) that are contained in the VMs 466(1)-(N) for each customer can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may run code in the containers 467(1)-(N) that request a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, and 400 may include components that are different and/or additional to the components shown in the figures. Further, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process, such as a virtual machine, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited, to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant identifier (ID). Each network resource of the multi-tenant computer network is tagged with a tenant ID. A tenant is permitted access to a particular network resource when the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset when the tenant and the particular application, data structure, and/or dataset are associated with a same tenant ID.

As an example, each database implemented by a multi-tenant computer network may be tagged with a tenant ID. A tenant associated with the corresponding tenant ID may access data of a particular database. As another example, each entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for each tenant, a set of applications that the tenant is authorized to access. For each application, a list of tenant IDs of tenants authorized to access the application is stored. A tenant is permitted access to a particular application when the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

This application may include references to certain trademarks. Although the use of trademarks is permissible in patent applications, the proprietary nature of the marks should be respected and every effort made to prevent their use in any manner that might adversely affect their validity as trademarks.

### 3. Computer System

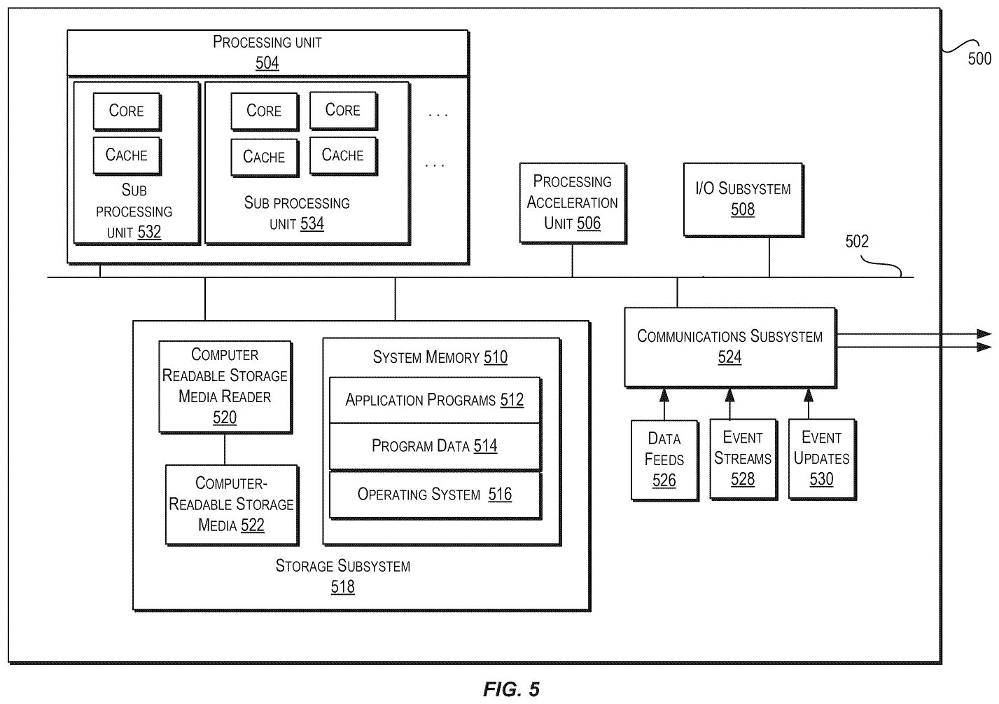

FIG. 5 illustrates an example computer system 500. An embodiment of the disclosure may be implemented upon the computer system 500. As shown in FIG. 5, computer system 500 includes a processing unit 504 that communicates with peripheral subsystems via a bus subsystem 502. These peripheral subsystems may include a processing acceleration unit 506, an I/O subsystem 508, a storage subsystem 518, and a communications subsystem 524. Storage subsystem 518 includes tangible computer-readable storage media 522 and a system memory 510.

Bus subsystem 502 provides a mechanism for letting the various components and subsystems of computer system 500 to communicate with each other as intended. Although bus subsystem 502 is shown schematically as a single bus, alternative embodiments of the bus subsystem may utilize multiple buses. Bus subsystem 502 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the IEEE P1386.1 standard.

Processing unit 504 controls the operation of computer system 500. Processing unit 504 can be implemented as one or more integrated circuits (e.g., a conventional microprocessor or microcontroller). One or more processors may be included in processing unit 504. These processors may include single core or multicore processors. In certain embodiments, processing unit 504 may be implemented as one or more independent processing units 532 and/or 534 with single or multicore processors included in each processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, the program code to be executed can be wholly or partially resident in processing unit 504 and/or in storage subsystem 518. Through suitable programming, processing unit 504 can provide various functionalities described above. Computer system 500 may additionally include a processing acceleration unit 506 that can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include medical imaging input devices such as computed tomography, magnetic resonance imaging, position emission tomography, or medical ultrasonography devices. User interface input devices may also include audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 500 to a user or other computer. For example, user interface output devices may include, without limitation, a variety of display devices that visually convey text, graphics and audio/video information, such as monitors, printers, speakers, headphones, automotive navigation systems, plotters, voice output devices, and modems.

Computer system 500 may comprise a storage subsystem 518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 504 provide the functionality described above. Storage subsystem 518 may also provide a repository for storing data used in accordance with the present disclosure.

As depicted in the example in FIG. 5, storage subsystem 518 can include various components, including a system memory 510, computer-readable storage media 522, and a computer readable storage media reader 520. System memory 510 may store program instructions, such as application programs 512, that are loadable and executable by processing unit 504. System memory 510 may also store data, such as program data 514, that is used during the execution of the instructions and/or data that is generated during the execution of the program instructions. Various programs may be loaded into system memory 510 including, but not limited to, client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random access memory (RAM)) and/or non-volatile memory (such as read-only memory (ROM), flash memory, etc.). Different types of RAM configurations may be provided, including a static random access memory (SRAM), a dynamic random access memory (DRAM), and others. In some implementations, system memory 510 may include a basic input/output system (BIOS) containing basic routines that help to transfer information between elements within computer system 500 such as during start-up.

Computer-readable storage media 522 may represent remote, local, fixed, and/or removable storage devices plus storage media for temporarily and/or more permanently containing, storing, computer-readable information for use by computer system 500, including instructions executable by processing unit 504 of computer system 500.

Computer-readable storage media 522 can include any appropriate media known or used in the art, including storage media and communication media, such as but not limited to volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include solid-state drives (SSD) based on non-volatile memory, such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments, communications subsystem 524 can include radio frequency (RF) transceiver components to access wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services, such as Twitter® feeds, Facebook® updates, web feeds such as Rich Site Summary (RSS) feeds, and/or real-time updates from one or more third party information sources.

Additionally, communications subsystem 524 may be configured to receive data in the form of continuous data streams. The continuous data streams may include event streams 528 of real-time events and/or event updates 530 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in FIG. 5 is intended as a non-limiting example. Many other configurations having more or fewer components than the system depicted in FIG. 5 are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### 4. Machine Learning Architecture

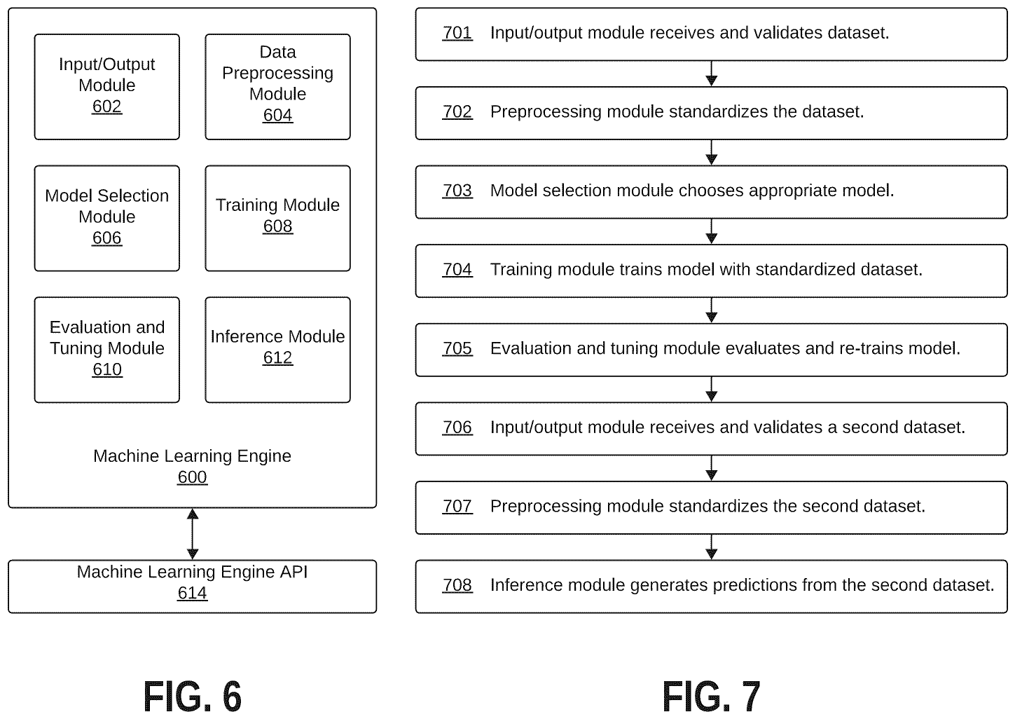

FIG. 6 illustrates a machine learning engine 600 in accordance with one or more embodiments. As illustrated in FIG. 6, machine learning engine 600 includes input/output module 602, data preprocessing module 604, model selection module 606, training module 608, evaluation and tuning module 610, and inference module 612.

In accordance with an embodiment, input/output module 602 serves as the primary interface for data entering and exiting the system, managing the flow and integrity of data. This module may accommodate a wide range of data sources and formats to facilitate integration and communication within the machine learning architecture.

In an embodiment, an input handler within input/output module 602 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 602 to be versatile in different operational contexts, whether processing historical datasets or streaming data.

In accordance with an embodiment, input/output module 602 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 602 includes an output framework designed to handle the distribution and exportation of outputs, predictions, or insights. Using the output framework, input/output module 602 formats these outputs into user-friendly and accessible formats, such as reports, visualizations, or data files compatible with other systems. Input/output module 602 also ensures secure and efficient transmission of these outputs to end-users or other systems in an embodiment and may employ encryption and secure data transfer protocols to maintain data confidentiality.

In accordance with an embodiment, data preprocessing module 604 transforms data into a format suitable for use by other modules in machine learning engine 600. For example, data preprocessing module 604 may transform raw data into a normalized or standardized format suitable for training ML models and for processing new data inputs for inference. In an embodiment, data preprocessing module 604 acts as a bridge between the raw data sources and the analytical capabilities of machine learning engine 600.

In an embodiment, data preprocessing module 604 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 604 may be configured to handle anomalies in different ways depending on context. Data preprocessing module 604 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 604 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 604 processes new data for inference, data preprocessing module 604 replicates the same preprocessing steps to ensure consistency with the training data format. This helps to avoid discrepancies between the training data format and the inference data format, thereby reducing the likelihood of inaccurate or invalid model predictions.

In an embodiment, model selection module 606 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 606 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 606 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 606 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 606 also considers computational efficiency and resource constraints. This is meant to help ensure the selected model is both accurate and practical in terms of computational and time requirements. In an embodiment, certain features of model selection module 606 are configurable such as a configured bias toward (or against) computational efficiency.

In accordance with an embodiment, training module 608 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 608 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 608 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 608 includes logic to handle different types of data and learning tasks. For instance, it includes different training routines for supervised learning (where the training data comes with labels) and unsupervised learning (without labeled data). In the case of deep learning models, training module 608 also manages the complexities of training neural networks that include initializing network weights, choosing activation functions, and setting up neural network layers.

In an embodiment, evaluation and tuning module 610 incorporates dynamic feedback mechanisms and facilitates continuous model evolution to help ensure the system's relevance and accuracy as the data landscape changes. Evaluation and tuning module 610 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 610 performs continuous model tuning by using hyperparameter optimization. Evaluation and tuning module 610 performs an exploration of the hyperparameter space using algorithms, such as grid search, random search, or more sophisticated methods like Bayesian optimization. Evaluation and tuning module 610 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 610 integrates data feedback and updates the model. Evaluation and tuning module 610 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 610 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 610 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 612 transforms data raw data into actionable, precise, and contextually relevant predictions. In addition to processing and applying a trained model to new data, inference module 612 may also include post-processing logic that refines the raw outputs of the model into meaningful insights.

In an embodiment, inference module 612 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 612 transforms the outputs of a trained model into definitive classifications. Inference module 612 employs the underlying model as a tool to generate probabilistic outputs for each potential class. It then engages in an interpretative process to convert these probabilities into concrete class labels.

In an embodiment, when inference module 612 receives the probabilistic outputs from the model, it analyzes these probabilities to determine how they are distributed across some or every potential class. If the highest probability is not significantly greater than the others, inference module 612 may determine that there is ambiguity or interpret this as a lack of confidence displayed by the model.

In an embodiment, inference module 612 uses thresholding techniques for applications where making a definitive decision based on the highest probability might not suffice due to the critical nature of the decision. In such cases, inference module 612 assesses if the highest probability surpasses a certain confidence threshold that is predetermined based on the specific requirements of the application. If the probabilities do not meet this threshold, inference module 612 may flag the result as uncertain or defer the decision to a human expert. Inference module 612 dynamically adjusts the decision thresholds based on the sensitivity and specificity requirements of the application, subject to calibration for balancing the trade-offs between false positives and false negatives.

In accordance with an embodiment, inference module 612 contextualizes the probability distribution against the backdrop of the specific application. This involves a comparative analysis, especially in instances where multiple classes have similar probability scores, to deduce the most plausible classification. In an embodiment, inference module 612 may incorporate additional decision-making rules or contextual information to guide this analysis, ensuring that the classification aligns with the practical and contextual nuances of the application.

In regression models, where the outputs are continuous values, inference module 612 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 612 incorporates domain-specific adjustments into its post-processing routine. This involves tailoring the model's output to align with specific industry knowledge or contextual information. For example, in financial forecasting, inference module 612 may adjust predictions based on current market trends, economic indicators, or recent significant events, ensuring that the outputs are both statistically accurate and practically relevant.

In an embodiment, inference module 612 includes logic to handle uncertainty and ambiguity in the model's predictions. In cases where inference module 612 outputs a measure of uncertainty, such as in Bayesian inference models, inference module 612 interprets these uncertainty measures by converting probabilistic distributions or confidence intervals into a format that can be easily understood and acted upon. This provides users with both a prediction and an insight into the confidence level of that prediction. In an embodiment, inference module 612 includes mechanisms for involving human oversight or integrating the instance into a feedback loop for subsequent analysis and model refinement.

In an embodiment, inference module 612 formats the final predictions for end-user consumption. Predictions are converted into visualizations, user-friendly reports, or interactive interfaces. In some systems, like recommendation engines, inference module 612 also integrates feedback mechanisms, where user responses to the predictions are used to continually refine and improve the model, creating a dynamic, self-improving system.

FIG. 7 illustrates the operation of a machine learning engine in one or more embodiments. In an embodiment, input/output module 602 receives a dataset intended for training (Operation 701). This data can originate from diverse sources, like databases or real-time data streams, and in varied formats, such as CSV, JSON, or XML. Input/output module 602 assesses and validates the data, ensuring its integrity by checking for consistency, data ranges, and types.

In an embodiment, training data is passed to data preprocessing module 604. Here, the data undergoes a series of transformations to standardize and clean it, making it suitable for training ML models (Operation 702). This involves normalizing numerical data, encoding categorical variables, and handling missing values through techniques like imputation.

In an embodiment, prepared data from the data preprocessing module 604 is then fed into model selection module 606 (Operation 703). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 608 trains the selected model with the prepared dataset (Operation 704). It implements learning algorithms to adjust the model's internal parameters, optimizing them to identify patterns and relationships in the training data. Training module 608 also addresses the challenge of overfitting by implementing techniques, like regularization and early stopping, ensuring the model's generalizability.

In an embodiment, evaluation and tuning module 610 evaluates the trained model's performance using the validation dataset (Operation 705). Evaluation and tuning module 610 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 602 receives a dataset intended for inference. Input/output module 602 assesses and validates the data (Operation 706).

In an embodiment, data preprocessing module 604 receives the validated dataset intended for inference (Operation 707). Data preprocessing module 604 ensures that the data format used in training is replicated for the new inference data, maintaining consistency and accuracy for the model's predictions.

In an embodiment, inference module 612 processes the new data set intended for inference, using the trained and tuned model (Operation 708). It applies the model to this data, generating raw probabilistic outputs for predictions. Inference module 612 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 614 allows for applications to leverage machine learning engine 600. In an embodiment, machine learning engine API 614 may be built on a RESTful architecture and offer stateless interactions over standard HTTP/HTTPS protocols. Machine learning engine API 614 may feature a variety of endpoints, each tailored to a specific function within machine learning engine 600. In an embodiment, endpoints such as/submitData facilitate the submission of new data for processing, while/retrieveResults is designed for fetching the outcomes of data analysis or model predictions. The MLE API may also include endpoints like/updateModel for model modifications and/trainModel to initiate training with new datasets.

In an embodiment, machine learning engine API 614 is equipped to support SOAP-based interactions. This extension involves defining a WSDL (Web Services Description Language) document that outlines the API's operations and the structure of request and response messages. In an embodiment, machine learning engine API 614 supports various data formats and communication styles. In an embodiment, machine learning engine API 614 endpoints may handle requests in JSON format or any other suitable format. For example, machine learning engine API 614 may process XML, and it may also be engineered to handle more compact and efficient data formats, such as Protocol Buffers or Avro, for use in bandwidth-limited scenarios.

In an embodiment, machine learning engine API 614 is designed to integrate WebSocket technology for applications necessitating real-time data processing and immediate feedback. This integration enables a continuous, bi-directional communication channel for a dynamic and interactive data exchange between the application and machine learning engine 600.

### 5. Resource Management System

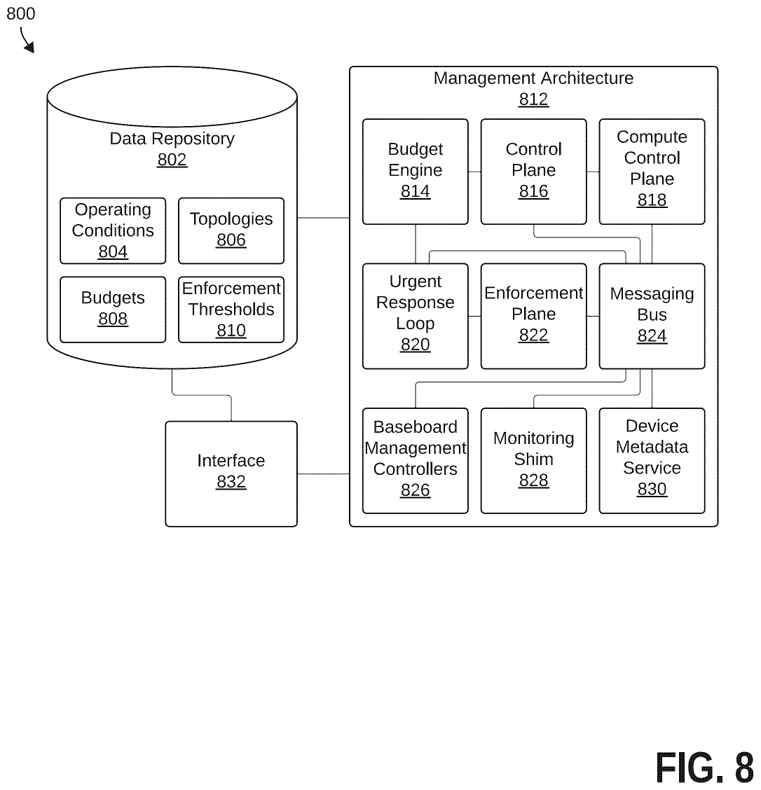

FIG. 8 illustrates a system 800 for resource management in accordance with one or more embodiments. As illustrated in FIG. 8, system 800 may include data repository 802, operating conditions 804, topologies 806, budgets 808, enforcement thresholds 810, management architecture 812, budget engine 814, control plane 816, compute control plane 818, urgent response loop 820, enforcement plane 822, messaging bus 824, baseboard management controllers (BMCs) 826, monitoring shim 828, device management service 830, and interface 832. In one or more embodiments, the system 800 may include more or fewer components than the components illustrated in FIG. 8. The components illustrated in FIG. 8 may be local to or remote from each other. The components illustrated in FIG. 8 may be implemented in software and/or hardware. Each component may be distributed over multiple applications and/or machines. Multiple components may be combined into one application and/or machine. Operations described with respect to one component may instead be performed by another component. Additional embodiments and/or examples relating to the management of resources are described by R01289NP and R01291NP. R01289NP and R01291NP are incorporated by reference in entirety as if set forth herein.

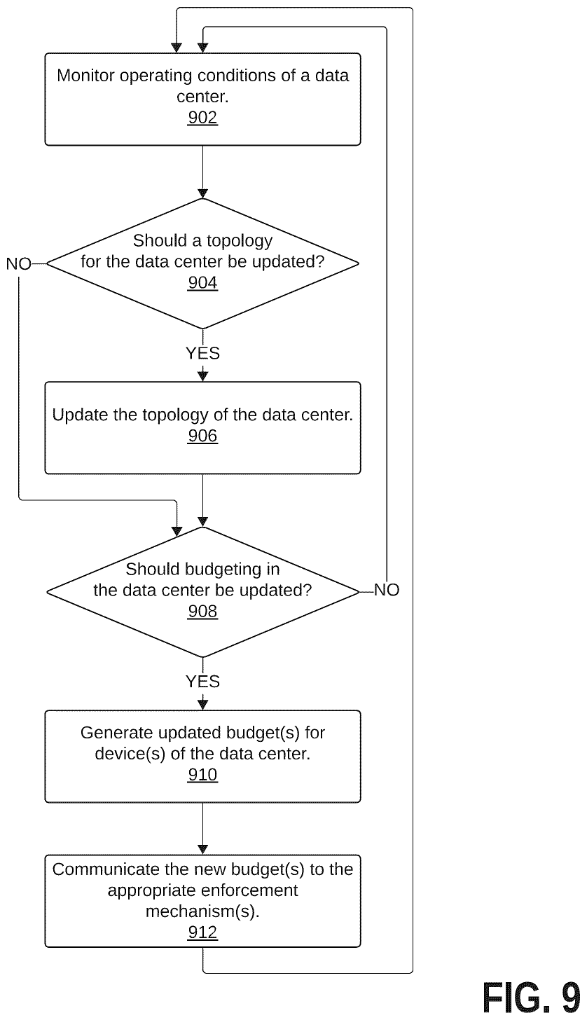

In an embodiment, system 800 refers to software and/or hardware configured to perform operations described herein for budgeting resources. General examples of resources that may be managed by system 800 include energy resources, computer resources, capital resources, administrative resources, and others. Example operations for budgeting resources are described below with reference to FIG. 9.

In an embodiment, techniques described herein for budgeting resources are applied to devices of a data center. To provide consistent examples, a data center is used at multiple points in this Detailed Description as an example setting for application of the techniques described herein. However, application to devices of a data center is not essential or necessary to practice the techniques described herein. These examples are illustrations that are provided to aid in the reader's understanding. The techniques described herein are equally applicable to settings other than a data center and devices other than those that may be found in a data center.

In an embodiment, data repository 802 refers to any type of storage unit and/or device (e.g., a file system, database, collection of tables, or any other storage mechanism) for storing data. Further, data repository 802 may include multiple different storage units and/or devices. The multiple different storage units and/or devices may or may not be of the same type or located at the same physical site. Furthermore, data repository 802 may be implemented or executed on the same computing system as other components of system 800. Additionally, or alternatively, data repository 802 may be implemented or executed on a computing system separate from other components of system 800. The data repository 802 may be communicatively coupled to other components of system 800 via a direct connection and/or via a network. As illustrated in FIG. 8, data repository 802 may include operating conditions 804, topologies 806, budgets 808, enforcement thresholds 810, and/or other information. The information illustrated within data repository 802 may be implemented across any of the components within system 800. However, this information is illustrated within data repository 802 for purposes of clarity and explanation.

In an embodiment, an operating condition 804 refers to information relevant to budgeting resources. For example, an operating condition 804 may be an attribute of a data center that is relevant to budgeting the utilization of resources by devices of the data center. Example operating conditions 804 of a data center include topological characteristics of the data center, characteristics of devices included in the data center, atmospheric conditions inside the data center, atmospheric conditions external to the data center, external limitations imposed on the data center, activity of data center operators, activity of data center users, historical patterns of activity regarding the data center, and other information that is relevant to budgeting for the data center.

In an embodiment, an operating condition 804 is a topological characteristic of a data center. As used herein, the term “topological characteristic” refers to any structural or organizational feature that defines the presence, arrangement, connectivity, and/or proximity between devices in a network of devices. For example, the topological characteristics of a data center may include the presence of devices in the data center and topological relationships between the devices in the data center. Example topological relationships include physical relationships, logical relationships, functional relations, and other relationships. A parent-child relationship between two devices is an example of a topological relationship.

In an embodiment, an operating condition 804 is a characteristic of a device included in a data center. For example, an operating condition 804 may be the status and/or capabilities of a physical device included in the data center. General examples of characteristics of a device that may be an operating condition 804 include the function of the device, specifications of the device, limitations of the device, the health of the device, the temperature of the device, resources that are utilized by the device, utilization of the device's resources, and other characteristics. An operating condition 804 may be a characteristic of a compute device, a power infrastructure device, an atmospheric regulation device, a network infrastructure device, a security device, a monitoring and management device, or another type of device. An operating condition 804 may be a characteristic of a device that includes a processor, and/or an operating condition 804 may be a characteristic of a device that does not include a processor. An operating condition 804 may be a characteristic of a software device, a hardware device, or a device that combines software and hardware. An operating condition 804 may be a characteristic of a device that is represented in a topology 806, and/or an operating condition 804 may be a characteristic of a device that is not represented in a topology 806.

In an embodiment, an operating condition 804 is a characteristic of a compute device included in a data center. As noted above, the term “compute device” refers to a device that provides computer resources (e.g., processing resources, memory resources, network resources, etc.) for computing activities (e.g., computing activities of data center users). Example compute devices that may be found in a data center include hosts (e.g., physical servers), racks of hosts, hyperconverged infrastructure nodes, AI/ML accelerators, edge computing devices, and others. A host is an example of a compute device because a host provides computer resources for computing activities of a user instance that is placed on the host. As used herein, the term “user instance” refers to an execution environment configured to perform computing tasks of a user (e.g., a user of a data center). Example user instances include containers, virtual machines, bare metal instances, dedicated hosts, and others.

In an embodiment, an operating condition 804 is a characteristic of a power infrastructure device included in a data center. As used herein, the term “power infrastructure device” refers to a device that is configured to generate, transmit, store, and/or regulate electricity. Example power infrastructure devices that may be included in a data center include generators, solar panels, wind turbines, transformers, inverters, rectifiers, switches, circuit breakers, transmission lines, uninterruptible power sources (UPSs), power distribution units (PDUs), busways, rack power distribution units (rPDUs), battery storage systems, power cables, and other devices. Power infrastructure devices may be utilized to distribute electricity to compute devices in a data center. For instance, in a simplified example configuration of an electricity distribution network in a data center, UPS(s) may be used to distribute electricity to PDU(s), the PDU(s) may be used to distribute electricity to busways, the busways may be used to distribute electricity to racks of hosts, and rPDUs in the racks of hosts may be used to distribute electricity to the hosts in the racks. To provide consistent examples, the foregoing simplified example configuration of an electricity distribution network is used at multiple points in this Detailed Description. These examples are provided purely to aid in the reader's understanding. The techniques described herein are equally applicable to any other configuration of an electricity distribution network.

In an embodiment, an operating condition 804 is a characteristic of an atmospheric regulation device included in a data center. As used herein, term “atmospheric regulation device” refers to any device that is configured to regulate an atmospheric condition. As used herein, the term “atmospheric condition” refers to the actual or predicted state of an atmosphere at a specific time and location. Example atmospheric regulation devices include computer room air conditioning (CRAC) units, computer room air handler (CRAH) units, chillers, cooling towers, in-row cooling systems, expansion units, hot/cold aisle containment systems, heating, ventilation, and air conditioning (HVAC) systems, heat exchangers, heat pumps, humidifiers, dehumidifiers, liquid cooling systems, particulate filters, and others.

In an embodiment, an operating condition 804 is an external limitation imposed on a data center. With respect to a data center, the term “external limitation” is used herein to refer to a limitation imposed on the data center that does not derive from the current capabilities of the data center. An external limitation may impede a data center from operating at a normal operating capacity of the data center. For example, an external limitation may be imposed on the data center if the data center is capable of working at a normal operating capacity, but it is nonetheless impossible, impractical, and/or undesirable for the data center to operate at the normal operating capacity. Example external limitations that may be imposed on a data center include an insufficient supply of resources to the data center (e.g., electricity, fuel, coolant, data center operators, etc.), the cost of obtaining resources that are used to operate the data center (e.g., the price of electricity), an artificial restriction imposed on the data center (e.g., government regulations), and other limitations.

In an embodiment, an operating condition 804 is an atmospheric condition. An operating condition 804 may be an atmospheric condition external to a data center, and/or an operating condition 804 may be an atmospheric condition internal to the data center. An operating condition 804 may be an atmospheric condition of a particular environment within a data center such as a particular room of the data center. Examples of atmospheric conditions that may be operating conditions 804 include temperature, humidity, pressure, density, air quality, water quality, air currents, water currents, altitude, weather conditions, and others. An operating condition 804 may be a predicted atmospheric condition. For example, an operating condition 804 may be forecasted state of an atmosphere in a geographical region where a data center is situated at a specific time.

In an embodiment, an operating condition 804 is a characteristic of a device that is not represented in a topology 806. As an example, assume that a topology 806 maps an electricity distribution network of a data center. In this example, there may be various devices in a data center that it is not practical to monitor closely or represent in the topology 806 of the data center. Examples of devices that may not be represented in the topology 806 of this example include appliances (e.g., refrigerators, microwaves, etc.), personal devices (e.g., phones, laptops, etc.), chargers for personal devices, electric vehicles charging from an external outlet of a data center, HVAC systems for workspaces of data center operators, and various other devices. While it may be impractical to closely monitor these devices or represent these devices in the topology 806, measurements and/or estimates of the power that is being drawn by these devices in this example may nonetheless be relevant to budgeting for the data center.

In an embodiment, an operating condition 804 is user input. User input describing operating conditions 804 may be received via interface 832. In an example, an operating condition 804 is described by user input that is received from a data center operator. In this example, the user input may describe topological characteristics of the data center, an emergency condition occurring in the data center, planned maintenance of a device, or any other information that is relevant to budgeting.

In an embodiment, a topology 806 refers to a set of one or more topological characteristics of a network of devices. A topology 806 may be a physical topology, and/or a topology 806 may be a logical topology. A topology 806 may include elements that represent physical devices, and/or a topology 806 may include elements that represent virtual devices. A topology 806 may include links between elements that represent topological relationships between devices. Example topological relationships between devices that may be represented by links between elements of a topology 806 include physical relationships, logical relationships, functional relations, and other relationships. An example topology 806 maps a resource distribution network. In other words, the example topology 806 includes elements that represent devices and links that represent pathways for resource distribution to and/or from the devices.

In an embodiment, a topology 806 is a set of one or more topological characteristics of a data center. Example devices that may be represented by elements in a topology 806 of a data center include compute devices, virtual devices, power infrastructure devices, atmospheric regulation devices, network infrastructure devices, security devices, monitoring and management devices, and other devices that support the operation of the data center. Example topological relationships between devices that may be represented by links between elements in a topology 806 of a data center include power cables, coolant piping, wired network pathways, wireless network pathways, spatial proximity, shared support devices, structural connections, and other relationships.

In an embodiment, a topology 806 represents a hierarchy of parent-child relationships between devices. As noted above, the term “parent device” is used herein to refer to a device that (a) distributes resources to another device and/or (b) includes another device that is a subcomponent of the device, and the term “child device” is used herein to refer to a device that (a) is distributed resources from another device and/or (b) is a subcomponent of another device. For example, a rack of hosts is considered a parent device to the hosts in the rack of hosts because (a) the hosts are subcomponents of the rack of hosts and/or (b) the rack of hosts may include one or more rPDUs that distribute electricity to the hosts in the rack. As another example, consider a busway that distributes electricity to a rack of hosts. In this other example, the busway is considered a parent device to the rack of hosts because the busway distributes a resource (i.e., electricity) to the rack of hosts. A device may simultaneously be a parent device and a child device. A device may possess multiple child devices, and the device may possess multiple parent devices. Two devices that share a common parent device may be referred to herein as “sibling devices.” A device that directly or indirectly distributes resources to another device may be referred to herein as an “ancestor device” of the other device. The term “descendant device” is used herein to identify a device that is directly or indirectly distributed resources from another device.

In an embodiment, a topology 806 represents a hierarchy of parent-child relationships between devices that maps to at least part of an electricity distribution network in a data center. As an example, consider a room of a data center that includes a UPS, multiple PDUs, multiple busways, and multiple racks of hosts. In this example, the UPS distributes electricity to the multiple PDUs, the multiple PDUs distribute electricity to the multiple busways, and the multiple busways distribute electricity to the multiple racks of hosts. The electricity that is distributed to the racks of hosts in this example is consumed by the hosts in the multiple racks of hosts. A corresponding topology 806 in this example may present a hierarchy of parent-child relationships where the UPS is situated at the top of the hierarchy and the racks of hosts are situated at the bottom of the hierarchy. In particular, the topology 806 of this example presents the UPS as a parent device to the multiple PDUs, and the topology 806 presents a PDU as a parent device to the busways that are distributed electricity through that PDU. Furthermore, the topology 806 of this example represents a busway as a parent device to the racks of hosts that are distributed electricity through that busway.

In an embodiment, a budget 808 refers to one or more defined allocations of resources. An allocation of a resource in a budget 808 may be a hard limit on the utilization of that resource, and/or an allocation of a resource in a budget 808 may be a soft limit on the utilization of that resource. Examples of resources that may be allocated by a budget 808 include energy resources, computer resources, capital resources, administrative resources, and other resources. An allocation of a resource in a budget 808 may define a quantity of that resource that can be utilized. Additionally, or alternatively, a budget 808 may include restrictions other than a quantified allocation of resources. For example, a budget 808 may restrict what a resource can be utilized for, who resources can be utilized for, when a resource can be utilized, and/or other aspects of a resource's utilization. A restriction that is defined by a budget 808 is referred to herein as a “budget constraint.”

In an embodiment, a budget 808 is a set of one or more budget constraints that are applicable to a device. For example, a budget 808 may be a set of budget constraint(s) that are applicable to a specific device in a data center. A budget 808 may be applicable to a single device, and/or a budget 808 may be applicable to multiple devices. A budget 808 may be applicable to a parent device, and/or a budget 808 may be applicable to a child device. A budget 808 for a device may include power constraints, thermal constraints, network constraints, use constraints, and/or other restrictions. As used herein, the term “power constraint” refers to a restriction relating to the utilization of energy. For instance, a power constraint may restrict the utilization of electricity. Example power constraints include maximum instantaneous power draws, maximum average power draws, load ratios for child devices, power allocation priorities, power throttling thresholds, redundancy power limits, restrictions on fuel consumption, carbon credits, and other restrictions. It should be understood that a power constraint need not be specified in a unit of power. As used herein, the term “thermal constraint” refers to a restriction relating to heat transfer. Example thermal constraints include maximum operating temperatures, restrictions on heat output, restrictions on coolant consumption, and other restrictions. As used herein, the term “coolant” refers to a substance that is configured to induce heat transfer. An example coolant is a fluid (e.g., a liquid or gas) that removes heat from a device or an environment. As used herein, the term “network constraint” refers to a restriction relating to the utilization of a network resource. Example network constraints include a permissible inbound bandwidth, a maximum permissible outbound bandwidth for the device, a maximum permissible aggregate bandwidth, and other restrictions. As used herein, the term “use constraint” refers to a restriction relating to how the computer resources (e.g., processing resource, memory resources, etc.) of a device may be utilized. Example use constraints include a maximum CPU utilization level, a maximum GPU utilization level, a maximum number of processing threads, restrictions on memory usage, limits on storage access or IOPS (Input/Output Operations Per Second), restrictions on virtual machine or container provisioning, and other restrictions.

In an embodiment, a budget 808 for a device is a conditional budget. As used herein, the term “conditional budget” refers to a budget 808 that is applied if one or more trigger conditions associated with the conditional budget are satisfied. In an example, a conditional budget 808 is tailored to a potential occurrence in a data center such as a failure of a device in the data center (e.g., a compute device, a power infrastructure device, an atmospheric regulation device, etc.), a significant temperature rise in the data center, an emergency command from a data center operator, and/or other abnormal operating conditions 804.

In an embodiment, an enforcement threshold 810 refers to a restriction that is used to implement budgeting or respond to an emergency condition. An example enforcement threshold 810 is a hard limit on the amount of resources that can be utilized by a device. An enforcement threshold 810 may include power constraints, thermal constraints, network constraints, use constraints, and/or other types of restrictions. As used herein, an enforcement threshold 810 that includes a power constraint is referred to as a “power cap threshold.”

In an embodiment, an enforcement threshold 810 is a restriction that is imposed on a descendant device to implement a budget constraint or enforcement threshold 810 that is applicable to an ancestor device. As an example, assume that a budget 808 assigned to a rack of hosts limits the power that may be drawn by the rack of hosts. In this example, the budget 808 assigned to the rack of hosts may be implemented by imposing power cap thresholds on the individual hosts in the rack of hosts. The utilization of a resource by a device may be simultaneously restricted by a budget 808 assigned to the device and an enforcement threshold 810 imposed on the device. An enforcement threshold 810 that limits the utilization of a resource by a device may be more stringent than a budget constraint assigned to the device that limits the utilization of that same resource. Therefore, an enforcement threshold 810 imposed on a device that limits the utilization of a resource by the device may effectively supersede a budget constraint assigned to the device that also restricts the utilization of that resource until the enforcement threshold 810 is lifted.

In an embodiment, management architecture 812 refers to software and/or hardware configured to manage resource utilization. As illustrated in FIG. 8, management architecture 812 may include budget engine 814, control plane 816, compute control plane 818, urgent response loop 820, enforcement plane 822, messaging bus 824, BMCs 826, monitoring shim 828, device metadata service 830, and/or other components. Management architecture 812 may include more or fewer components than the components illustrated in FIG. 8. Operations described with respect to one component of management architecture 812 may instead be performed by another component of management architecture 812. A component of management architecture 812 may be implemented or executed on the same computing system as other components of system 800, and/or a component of management architecture 812 may be implemented on a computing system separate from other components of system 800. A component of management architecture 812 may be communicatively coupled to other components of system 800 via a direct connection and/or via a network.

In an embodiment, budget engine 814 refers to software and/or hardware configured to generate budgets 808. Budget engine 814 is configured to autonomously generate budgets 808, and/or budget engine 814 is configured to generate budgets 808 in collaboration with a user of system 800. Budget engine 814 is configured to generate budgets 808 based on operating conditions 804, topologies 806, and/or other information. Budget engine 814 is configured to dynamically update budgets 808 in response to determining an actual or predicted change to operating conditions 804 and/or topologies 806. Budget engine 814 is configured to communicate with other components of system 800, components external to system 800, and/or users of system 800 via messaging bus 824, API(s), and/or other means of communication. Budget engine 814 may be configured to communicate with a user of system 800 via interface 832.

In an embodiment, budget engine 814 is configured to generate budgets 808 for devices in a data center. Budget engine 814 may be configured to generate budgets 808 for hardware devices, software devices, and/or devices that combine software and hardware. General examples of devices that budget engine 814 may generate budgets 808 for include compute devices, virtual devices, power infrastructure devices, atmospheric regulation devices, network infrastructure devices, security devices, monitoring and management devices, and other devices that support the operation of a data center.

In an embodiment, budget engine 814 is configured to monitor topological characteristics of a data center, and budget engine 814 is configured to maintain one or more topologies 806 of the data center. In this embodiment, budget engine 814 is further configured to generate budgets 808 for devices represented in a topology 806 of the data center. As an example, assume that a topology 806 of a data center reflects an electricity distribution network of the data center at least in part. For instance, the topology 806 of the data center in this example might indicate that a UPS distributes electricity to multiple PDUs, the multiple PDUs distribute electricity to multiple busways, the multiple busways distribute electricity to multiple racks of hosts, and rPDUs embedded in the racks of hosts distribute electricity to the hosts in the racks. In this example, budget engine 814 may be configured to generate individual budgets 808 for the UPS, the PDUs, the busways, the racks of hosts, the rPDUs in the racks of hosts, and/or the hosts. In general, the devices in a data center that are represented in a topology 806 of the data center and assigned individual budgets 808 by budget engine 814 may vary depending on the level of granularity that is needed for budgeting for the data center. For instance, in one example a lowest-level device to be assigned a budget 808 by budget engine 814 may be a rack of hosts, and in another example a lowest-level device to be assigned a budget by budget engine 814 may be a busway.

In an embodiment, budget engine 814 is configured to dynamically update a topology 806 of a data center in response to detecting a change to a topological characteristic of the data center. For example, budget engine 814 may be configured to dynamically update a topology 806 of a data center in response to detecting the presence of a new device in the data center, the absence of a previously-detected device in the data center, a change to the manner that resources are distributed to devices in the data center, and other changes to topological characteristics of the data center.

In an embodiment, budget engine 814 is configured to dynamically update budgeting in a data center in response to determining an actual or predicted change to the operating conditions 804 of a data center. For example, budget engine 814 may be configured to generate updated budgets 808 for devices in a data center in response to determining an actual or predicted change to topological characteristics of the data center, characteristics of devices included in the data center, atmospheric conditions inside the data center, atmospheric conditions external to the data center, external limitations imposed on the data center, and/or other operating conditions 804.

In an embodiment, budget engine 814 is configured to generate budgets 808 for devices by applying one or more trained machine learning models to the operating conditions 804 of a data center. Example training data that may be used to train a machine learning model to predict a change in the operating conditions 804 of a data center includes historical operating conditions 804 of the data center, historical operating conditions 804 of other data centers, theoretical operating conditions 804 of the data center, and/or other training data. An example set of training data may define an association between (a) a set of operating conditions 804 in a data center (e.g., topological characteristics of the data center, characteristics of individual devices, atmospheric conditions, etc.) and (b) a set of budgets 808 that are to applied in that set of operating conditions 804. A machine learning model applied to generate budgets 808 for devices in a data center may be trained further based on feedback pertaining to budgets 808 generated by the machine learning model.

In an embodiment, budget engine 814 is configured to predict a change to operating conditions 804, and budget engine 814 is configured to generate budget(s) 808 based on the predicted change. Example inputs that may be a basis for budget engine 814 predicting a change to the operating conditions 804 of a data center include a current trend in the operating conditions 804 of the data center, historical patterns in the operating conditions 804 of the data center, input from data center operators, and other information. Example occurrences that may be predicted by budget engine 814 include a failure of a device, maintenance of a device, a change in atmospheric conditions within the data center, a change in atmospheric conditions external to the data center, an increase or decrease in the workloads imposed on devices in the data center, and other occurrences.

In an embodiment, budget engine 814 is configured to predict a change in the operating conditions 804 of a data center by applying one or more trained machine learning models to the operating conditions 804 of the data center. Example training data that may be used to train a machine learning model to predict a change in the operating conditions 804 of the data center includes historical operating conditions 804 of the data center, historical operating conditions 804 of other data centers, theoretical operating conditions 804 of the data center, and/or other training data. A machine learning model may be further trained to predict changes in a data center based on feedback pertaining to predictions output by the machine learning model. In an example, a machine learning model is trained to predict a failure of a device in a data center. In this example, a set of training data used to train the machine learning model may define an association between (a) a failure of a device in a data center and (b) one or more operating conditions 804 of the data center that are related to the failure of the device. If an application of the machine learning model outputs a predicted failure of a device in this example, budget engine 814 is configured to (a) generate new budget(s) that are formulated to reduce the risk of the predicted failure occurring and/or (b) generate new budget(s) that are to be applied in the event of the predicted failure occurring (i.e., conditional budget(s) 808). In another example, a machine learning model is trained to predict the inability of atmospheric regulation devices to maintain normal operating conditions 804 in a data center.

In an embodiment, budget engine 814 leverages one or more machine learning algorithms that are tasked with training one or more machine learning models to predict changes to operating conditions 804 of a data center and/or generate budgets 808 for devices in a data center. A machine learning algorithm is an algorithm that can be iterated to train a target model that best maps a set of input variables to an output variable, using a set of training data. The training data includes datasets and associated labels. The datasets are associated with input variables for the target model. The associated labels are associated with the output variable of the target model. The training data may be updated based on, for example, feedback on the predictions by the target model and accuracy of the current target model. Updated training data is fed back into the machine learning algorithm, that in turn updates the target model. A machine learning algorithm generates a target model such that the target model best fits the datasets of training data to the labels of the training data. Additionally, or alternatively, a machine learning algorithm generates a target model such that when the target model is applied to the datasets of the training data, a maximum number of results determined by the target model matches the labels of the training data. Different target models be generated based on different machine learning algorithms and/or different sets of training data. A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering. Additional embodiments and/or examples related to machine learning techniques that may be incorporated by system 800 and leveraged by budget engine 814 are described above in Section 4 titled “Machine Learning Architecture.”

In an embodiment, budget engine 814 is configured to communicate operating conditions 804, topologies 806, budgets 808, and/or other information to one or more other components of system 800. For instance, budget engine 814 may be configured to communicate operating conditions 804, topologies 806, budgets 808, and/or other information to control plane 816, urgent response loop 820, and/or other components of the system. In an example, budget engine 814 presents an API that can be leveraged to pull operating conditions 804, topologies 806, budgets 808, and/or other information from budget engine 814. In another example, budget 814 leverages an API to push operating conditions 804, topologies 806, budgets 808, and/or other information to other components of system 800. In yet another example, budget engine 814 is configured to communicate operating conditions 804, topologies 806, budgets 808, and/or other information via messaging bus 824.

In an embodiment, control plane 816 refers to software and/or hardware configured to collect, process, and/or distribute information that is relevant to resource management. Control plane 816 is configured to collect information from other components of system 800, users of system 800, and/or other sources of information. Control plane 816 is configured to distribute information to other components of system 800, users of system 800, and/or other recipients. Control plane 816 is configured to obtain and/or distribute information via messaging bus 824, one or more APIs, and/or other means of communication. Control plane 816 may be configured to communicate with a user of system 800 via interface 832.

In an embodiment, control plane 816 is a layer of management architecture 802 that is configured to collect, process, and/or distribute information that is relevant to managing the utilization of resources by devices in a data center. Example information that may be collected, processed, and/or distributed by control plane 816 includes operating conditions 804, topologies 806, budgets 808, compute metadata, user input, and other information.

In an embodiment, control plane 816 is configured to collect, process, and/or distribute operating conditions 804, topologies 806, budgets 808, and/or other information. Control plane 816 is configured to collect operating conditions 804, topologies 806, budgets 808 and/or other information from budget engine 814 and/or other sources of information. Control plane 816 is configured to selectively communicate operating conditions 804, topologies 806, budgets 808, and/or other information to enforcement plane 822 and/or other recipients. In an example, control plane 816 is configured to collect operating conditions 804, topologies 806, budgets 808, and/or other information associated with devices in a data center by leveraging an API that allows control plane 816 to pull information from budget engine 814. In this example, control plane 816 is further configured to distribute the operating conditions 804, topologies 806, budgets 808, and/or other information associated with the devices in the data center to components of enforcement plane 822 that manage those devices by selectively publishing this information to messaging bus 824.

In an embodiment, control plane 816 is configured to collect, process, and distribute compute metadata and/or other information. As used herein, the term “compute metadata” refers to information associated with compute devices and/or compute workloads. Example compute metadata includes metadata of user instances placed on compute devices (referred to herein as “user instance metadata”), metadata of compute devices hosting user instances (referred to herein as “compute device metadata”), and other information. Compute metadata collected by control plane 816 may originate from compute control plane 818, device metadata service 830, and/or other sources of information. Control plane 816 is configured to process compute metadata to generate metadata that can be used as a basis for budget implementation determinations (referred to herein as “enforcement metadata”). Control plane 816 is configured to selectively communicate compute metadata, enforcement metadata, and/or other information to enforcement mechanisms of enforcement plane 822 and/or other recipients. In an example, control plane 816 is configured to monitor messaging bus 824 for compute metadata that is published to messaging bus 824 by compute control plane 818 and/or device metadata service 830. Based on compute metadata obtained by control plane 816 from messaging bus 824 in this example, control plane 816 is configured to generate enforcement metadata, and control plane 816 is configured to distribute the compute metadata, enforcement metadata, and/or other information to enforcement mechanisms of enforcement plane 822 by selectively publishing this information to messaging bus 824.

In an embodiment, compute control plane 818 refers to software and/or hardware configured to manage the workloads of compute devices. Compute control plane 818 is configured to communicate with other components of system 800, components external to system 800, and/or users of system 800 via messaging bus 824, API(s), and/or other means of communication. Compute control plane 818 may be configured to communicate with a user of system 800 via interface 832.

In an embodiment, compute control plane 818 is a layer of management architecture 812 configured to manage user instances that are placed on compute devices of a data center. For instance, compute control plane 818 may be configured to provision user instances, place user instances, manage the lifecycle of user instances, track the performance and health of user instances, enforce isolation between user instances, manage compute metadata, and perform various other functions.

In an embodiment, compute control plane 818 is configured to selectively place user instances on compute devices of a data center. In an example, compute control plane 818 is configured to select a compute device for placement of a user instance based on characteristics of the compute device, characteristics of related devices (e.g., ancestors, siblings, etc.), budgets 808 assigned to the compute device, budgets 808 assigned to related devices, enforcement thresholds 810 imposed on the device, enforcement thresholds 810 imposed on related devices, compute metadata associated with the compute device, operating conditions 804, and/or other inputs.

In an embodiment, compute control plane 818 is configured to place a user instance on a compute device based on a predicted impact of placing the user instance on the compute device. For example, if a predicted impact of placing a user instance on a host is not expected to result in the exceeding of any restrictions associated with the host, compute control plane 818 may be configured to select that host for placement. Example restrictions that may influence the placement of user instances on compute devices by compute control plane 818 include budget constraints, enforcement thresholds 810, hardware limitations of the compute devices, hardware limitations of power infrastructure devices that support the compute devices (e.g., a trip setting of a circuit breaker), hardware limitations of atmospheric regulation devices that support the compute devices, and various other restrictions. A restriction associated with a compute device is specific to the compute device, or the restriction associated with the compute device is not specific to the compute device. Examples restrictions that may be specific to a compute device include a budget 808 assigned to the compute device, enforcement thresholds 810 imposed on the compute device, hardware constraints of the compute device, and others. Example restrictions that are typically not specific to any one compute device include a budget 808 assigned to an ancestor device of the compute device, an enforcement threshold 810 assigned to an ancestor device of the compute device, a trip setting of a circuit breaker that regulates electricity distribution to the compute device, a cooling capacity of an atmospheric regulation device that regulates an environment (e.g., a room of a data center) that includes the compute device, and other restrictions.

In an embodiment, compute control plane 818 is configured to serve as a mechanism for enacting budgets 808 and enforcement thresholds 810 by preventing additional workloads from being assigned to compute devices. For example, compute control plane 818 may prevent new user instances being placed on compute devices to reduce the resource consumption of the compute devices. By reducing the resource consumption of compute devices, compute control plane 818 reduces the resources that are drawn by ancestor devices of the compute devices. In this way, compute control plane 818 may serve as a mechanism for enacting budgets 808 and enforcement thresholds 810 of child devices and parent devices. A compute device is referred to herein as being “closed” if placing additional user instances on the compute device is currently prohibited, and the compute device is referred to herein as being “open” if placing additional user instances on the compute device is not currently prohibited. An ancestor device (e.g., a power infrastructure device) is referred to herein as being “closed” if placing additional user instances on compute devices that are descendant devices of the ancestor device is currently prohibited, and the ancestor device is referred to herein as being “open” if placing additional user instances on compute devices that are descendant devices of the ancestor device is not currently prohibited. As an example, assume that a busway distributes energy to multiple racks of hosts. If the busway is closed to placement in this example, no additional user instances can be placed on the hosts in the multiple racks of hosts unless the busway is subsequently reopened.

In an embodiment, compute control plane 818 is configured to communicate compute metadata to budget engine 814 and/or other components of system. In an example, compute control plane 818 is configured to communicate compute metadata to budget engine 814 by publishing the compute metadata to messaging bus 824. In this example, compute control plane 818 is configured to publish updated compute metadata to messaging bus 824 when a user instance is launched, updated, or terminated.

In an embodiment, urgent response loop 820 refers to software and/or hardware configured to (a) monitor devices for emergency conditions and (b) trigger responses to emergency conditions. For example, urgent response loop 820 may be configured to trigger the implementation of emergency restrictions on resource utilization in response to detecting an emergency condition. In general, urgent response loop 820 may act as a mechanism for rapidly responding to an emergency condition until a more comprehensive response is formulated by other components of the system and/or the emergency condition ceases to exist. Urgent response loop 820 is configured to communicate with other components of system 800, components external to system 800, and/or users of system 800 via messaging bus 824, API(s), and/or other means of communication. Urgent response loop 820 may be configured to communicate with a user of system 800 via interface 832.

In an embodiment, urgent response loop 820 is configured to implement urgent restrictions on resource utilization in response to detecting an emergency condition in a data center. Urgent response loop 820 is configured to communicate commands for restricting resource utilization to enforcement plane 822 and/or other recipients. Restrictions imposed by urgent response loop 820 may remain in effect until budget engine 814 and/or other components of the system 800 (e.g., budget engine 814) have developed a better understanding of current operating conditions 804 and can generate budgets 808 that are better tailored to responding to the situation. In an example, urgent response loop 820 is configured to implement emergency power capping on devices of a data center in response to detecting an emergency condition in the data center. Urgent response loop 820 may be configured to implement budgets 808 (e.g., conditional budgets 808), enforcement thresholds 810, and/or other types of restrictions. Example conditions that may result in urgent response loop 820 imposing restrictions on devices include a failure of a device in the data center (e.g., a compute device, a power infrastructure device, an atmospheric regulation device, etc.), a significant change in electricity consumption, a significant change in electricity supply, a significant change in temperature, a command from a user of system 800, and other conditions.

In an embodiment, urgent response loop 820 is configured to implement a one-deep-cut policy in response to an emergency operating condition 804. An example one-deep-cut policy dictates that maximum enforcement thresholds 810 are imposed on each of the devices in a topology 808 of a data center. Another example one-deep-cut policy dictates that maximum enforcement thresholds 810 are imposed on a subset of the devices that are represented in a topology 808 of a data center. An example maximum enforcement threshold 810 for a device limits the resource consumption of the device to a lowest value that can be sustained while the device remains operational for the device's intended purpose.

In an embodiment, enforcement plane 822 refers to software and/or hardware configured to manage the implementation of restrictions on resource utilization. Internal communications within enforcement plane 822 may be facilitated by messaging bus 824 and/or other means of communication. Enforcement plane 822 is configured to communicate with other components of system 800, components external to system 800, and/or users of system 800 via messaging bus 824, API(s), and/or other means of communication. Enforcement plane 822 may be configured to communicate with a user of system 800 via interface 832.

In an embodiment, enforcement plane 822 is configured to determine enforcement thresholds 810 that can be used to implement restrictions that are applicable to devices. Enforcement plane 822 may implement a restriction that is applicable to one device by determining enforcement threshold(s) 810 for other device(s). For instance, enforcement plane 822 is configured to implement a budget 808 assigned to a device by determining enforcement threshold(s) 810 for child device(s) of the device. In an example, enforcement plane 822 implements a power-based budget constraint assigned to a PDU by determining power cap thresholds for busways that are distributed electricity from the PDU. Enforcement plane 822 is further configured to implement an enforcement threshold 810 that is imposed on a device by determining enforcement threshold(s) 810 for child device(s) of the device. For example, enforcement plane 822 may implement a power cap threshold imposed on a busway by determining additional power cap thresholds for racks of hosts that are distributed electricity from the busway. Furthermore, in this example, enforcement plane 822 may implement a power cap threshold imposed on a rack of hosts by determining power cap thresholds for hosts that are included in the rack of hosts. Ultimately, enforcement thresholds 810 imposed on devices by enforcement plane 822 are enforced by enforcement mechanisms of system 800 that limit the activity of those devices. The manner that an enforcement threshold 810 should be enforced on a device may be defined in the enforcement threshold 810 by enforcement plane 822. Example enforcement mechanisms that may be leveraged by enforcement plane 822 to enforce an enforcement threshold 810 include compute control plane 818, BMCs 826, a user instance controller operating on a hypervisor level of compute devices, an enforcement agent executing in a computer system of a data center user, and other enforcement mechanisms.

In an embodiment, enforcement plane 822 is configured to instruct a BMC 826 of a compute device to enact an enforcement thresholds 810 that is imposed by enforcement plane 822 on the compute device. By enacting an enforcement threshold 810 imposed on a compute device, a BMC of the compute device may contribute to bringing ancestor devices of the compute device into compliance with budgets 808 and/or enforcement thresholds 810 that are applicable to the ancestor devices.

In an embodiment, enforcement plane 822 is configured to instruct compute control plane 818 to enforce an enforcement threshold 810 that has been imposed on the device. In an example, enforcement plane 822 instructs compute control plane 818 to enforce a power cap threshold imposed on a host by closing that host. As a result, additional user instances cannot subsequently be placed on the host while the host remains closed, and the power consumption of the host may be reduced in this example. In another example, enforcement plane 822 instructs compute control plane 818 to enforce a power cap threshold imposed on a power infrastructure device (e.g., a UPS, a busway, a PDU, etc.) by closing the power infrastructure device. As a result, additional user instances cannot be placed on compute devices that are distributed electricity through the power infrastructure device, and the power draw of the power infrastructure device may be reduced in this other example.

In an embodiment, enforcement plane 822 is configured to instruct a user instance controller to restrict the activity of a user instance that is placed on a compute device. Enforcement plane 822 may be configured to instruct a user instance controller indirectly through compute control plane 818. In an example, enforcement plane 822 is configured to instruct a VM controller residing on a hypervisor level of a host to enforce a power cap threshold imposed on the host by limiting the activity of a user instance placed on the host. Directing a user instance controller to limit the activity of user instances may serve as a mechanism for fine-grain enforcement of budgets 808, enforcement thresholds 810, and/or other restrictions. For instance, a user instance controller may be configured to implement an enforcement threshold 810 in a manner that limits the impact to a subset of users.

In an embodiment, enforcement plane 822 is configured to instruct an enforcement agent executing on a computer system of a user to restrict the activity of user instances that are owned by that user. For example, enforcement plane 822 may instruct an enforcement agent executing on a computer system of a data center user to enforce an enforcement threshold 810 imposed on a host by limiting the activities of a user instance placed on the host that is owned by the data center user. Instructing an enforcement agent executing on a computer system of a user may serve as a mechanism for fine-grain enforcement of budgets 808, enforcement thresholds 810, and/or other restrictions.

In an embodiment, enforcement plane 822 includes one or more controllers. As used herein, the term “controller” refers to software and/or hardware configured to manage a device. An example controller is a logical control loop that is configured to manage a device represented in a topology 806 of a data center. A device managed by a controller may be a parent device and/or a child device. Enforcement plane 822 may include a hierarchy of controllers that corresponds to a hierarchy of parent-child relationships between devices represented in a topology 806 of a data center. As used herein, the term “parent controller” refers to a controller of a parent device, and the term “child controller” refers to a controller of a child device.

In an embodiment, a controller of enforcement plane 822 is a parent controller, or the controller is a leaf-level controller. As used herein, the term “leaf-level controller” refers to a controller residing in the lowest level of a hierarchy of controllers. In other words, a leaf-level controller is a controller that has no child controllers in enforcement plane 822. The term “leaf-level device” is used herein to identify a device managed by a leaf-level controller. It should be noted that a leaf-level device may have child devices whereas a leaf-level controller does not have child controllers. In an example, leaf-level devices in a data center are racks of hosts. In other words, the controllers managing the racks of hosts in this example are leaf-level controllers. In general, the type of devices in a data center that are managed by leaf-level controllers may vary depending on the level of granularity that is appropriate for budgeting for the data center. In another example, a leaf-level device is an rPDU, a busway, a PDU, a UPS, or another device. As used herein, the term “rPDU controller” may be used to identify a controller of an rPDU, the term “rack controller” may be used to identify a controller of a rack of hosts, the term “busway controller” may be used to identify a controller of a busway, the term “PDU controller” may be used to identify a controller of a PDU, and the term “UPS controller” may be used to identify a controller of a UPS.

In an embodiment, a controller (e.g., a parent controller or a leaf-level controller) spawned in enforcement plane 822 to manage a device is configured to monitor the status of the device. To this end, a controller of a device may be configured to monitor the resources that are being utilized by the device, the health of the device, the temperature of the device, the occupancy of the device, enforcement thresholds 810 that are currently imposed on the device, theoretical enforcement thresholds 810 that could be imposed on the device, and/or other information pertaining to the status of the device. A controller of a device may obtain information pertaining to the status of the device by aggregating information that is pertinent to the status of the device's descendant devices. For example, a controller of a rack of hosts may determine the power that is being drawn by the rack of hosts by aggregating power consumption measurements of individual hosts in the rack of hosts. If a controller of a device is a parent controller, the controller may obtain measurements of the resources that are being utilized by the device's ancestor devices (e.g., child devices and/or further descendant devices) from the controller's child controllers. If a controller of a device is a leaf-level controller, the controller may obtain measurements of resources that are being utilized by the device's ancestor devices of the device from BMCs of the ancestor devices. By determining the aggregate resource consumption of a device's descendant devices, a controller of the device may discern if the device is exceeding or at risk of exceeding any restrictions that are applicable to the device. If a controller of a device possesses a parent controller of a parent device, the controller may be configured to report the aggregate resource consumption of the device's descendant devices to the parent controller so that the parent controller can, in turn, determine the aggregate resource consumption of the parent device's descendant devices. As an example, consider a busway that distributes electricity to multiple racks of hosts. In this example, a controller of the busway determines the aggregate power that is drawn by the busway based on individual power draw values reported to the busway controller by the controllers of the multiple racks of hosts. If the busway controller possesses a parent controller in enforcement plane 822 in this example, the busway controller is configured to report the aggregate power draw of the busway to the parent controller. For instance, if the busway is distributed electricity through a PDU in this example, the busway controller may report the aggregate power draw of the busway to a controller of the PDU so that the PDU controller can determine the aggregate power draw of the PDU. Communications between controllers are facilitated by messaging bus 824 and/or other means of communication.

In an embodiment, a controller (e.g., a parent controller or a leaf-level controller) spawned in enforcement plane 822 to manage a device is configured to implement budgets 808 assigned to the device. A controller of a device (e.g., a UPS, a PDU, a busway, a rack of hosts, an rPDU, etc.) is configured to implement a budget 808 assigned to the device by determining enforcement thresholds 810 to impose on child devices. A controller of a device is configured to determine enforcement thresholds 810 for child devices based on information reported by child controllers, information reported by BMCs, enforcement metadata, and/or other information. A controller of a device is configured to communicate enforcement thresholds 810 to child controllers of child devices via messaging bus 824 and/or other means of communication.

In an embodiment, a controller (e.g., a parent controller or a leaf-level controller) spawned in enforcement plane 822 to manage a device is configured to implement enforcement thresholds 810 imposed on the device. A controller of a device is configured to implement an enforcement threshold 810 assigned to the device by determining enforcement threshold 810 to impose on child devices. A controller of device is configured to determine enforcement thresholds 810 for child devices based on information reported by BMCs, information reported by child controllers, enforcement metadata, and/or other information. A controller of a device is configured to communicate enforcement thresholds 810 to child controllers of child devices via messaging bus 824 and/or other means of communication.

In an embodiment, a controller (e.g., a parent controller or a leaf-level controller) included in enforcement plane 822 is configured to generate heartbeat communications. As used herein, the term “heartbeat communication” refers to a message indicating the health and/or state of a controller. In an example, a controller is configured to periodically generate heartbeat communications (e.g., once every 60 seconds) so that other components of system 800 can monitor the functionality of enforcement plane 822. In this example, the controller may communicate the heartbeat communications via messaging bus 824 and/or other means of communication.

In an embodiment, enforcement plane 822 includes one or more controller directors, and enforcement plane 822 includes one or more controller managers. As used herein, the term “controller director” refers to software and/or hardware configured to manage the operations of enforcement plane 822, and the term “controller manager” refers to software and/or hardware configured to manage a set of one or more controllers included in enforcement plane 822. A controller director is configured to direct the operations of controller manager(s). An example controller director monitors messaging bus 824 for updated topological information, budgeting information, workload characteristics, heartbeat communications, and/or other updated information that may be distributed to enforcement plane 822 from control plane 816 and/or other sources of information. Based on the updated information obtained by the example controller director, the example controller director may generate and transmit instructions to an example controller manager. Pursuant to instructions from the example controller director, the example controller manager may spawn new controller(s), redistribute existing controller(s), delete existing controller(s), and/or perform other operations.

In an embodiment, messaging bus 824 refers to software and/or hardware configured to facilitate communications to and/or from components of system 800. Messaging bus 824 offers one or more APIs that can be used by components of system 800, components external to system 800, and/or users of system 800 to publish messages to messaging bus 824 and/or retrieve messages from messaging bus 824. By facilitating rapid communications between components of system 800, messaging bus 824 allow components of system 800 to quickly respond to changing circumstances (e.g., by implementing restrictions on resource utilization).

In an embodiment, messaging bus 824 is a cluster of interconnected computing nodes that facilitates the storage, distribution, and processing of one or more data streams. An example node of messaging bus 824 is a server that is configured to store and manage data (referred to herein as a “broker”). Information published to messaging bus 824 is organized into one or more categories of information that are referred to herein as “topics.” As used herein, the term “publisher” refers to an entity that publishes information to a topic of messaging bus 824, and the term “consumer” refers to an entity that reads information from a topic of messaging bus 824. Information published to a topic of messaging bus 824 may be collectively consumed by a set of one or more consumers referred to herein as a “consumer group.” Example topics that may be maintained by messaging bus 824 include a topology topic, a budgets topic, a BMC data topic, a BMC response topic, an aggregated data topic, an enforcement command topic, a user instance metadata topic, a compute device metadata topic, an enforcement metadata topic, an enforcement alert topic, a heartbeat communications topic, a placement metadata topic, and other topics. A topic of the messaging bus 824 is typically organized into one or more subcategories of data that are referred to herein as “partitions.” The messages published to a topic are divided into the partition(s) of the topic. A message published to a topic may be assigned to a partition within the topic based on a key attached to the message. Messages that attach the same key are assigned to the same partition within a topic. A consumer of a consumer group may be configured to monitor a specific set of one or more partitions within a topic. Thus, a publisher of a message to a topic may direct the message to a specific consumer by attaching a key to that message that corresponds to a partition monitored by that specific consumer.

In an embodiment, messaging bus 824 includes one or more topology topics. A topology topic includes topological information and/or other information. Information is published to a topology topic by budget engine 814 and/or other publishers. Information published to a topology topic is consumed by enforcement plane 822 and/or other consumers. An example partition of a topology topic corresponds to an element in a topology 806 of a data center that represents a device in the data center. An example key attached to a message published to a topology topic is an element ID of an element in a topology 806 of a data center that represents a device in the data center. An example message published to a topology topic includes a timestamp, resource consumption metrics of the particular device (e.g., a 95% power draw value), the type of the particular device (e.g., BMC, rPDU, rack of hosts, busway, PDU, UPS, etc.), element IDs corresponding to child devices of the particular device, element IDs corresponding to parent devices of the particular device, and/or other information.

In an embodiment, messaging bus 824 includes one or more budgets topics. A budgets topic includes budgets 808 for devices and other information related to budgeting. Information is published to a budgets topic by control plane 816, urgent response loop 820, and/or other publishers. Information published to a budgets topic is consumed by enforcement plane 822 and/or other consumers. An example partition of a budgets topic corresponds to an clement in a topology 806 of a data center that represents a device in the data center. An example key attached to a message published to a budgets topic is an element ID of an element in a topology 806 of a data center that represents a device in the data center. An example message published to a budgets topic includes a timestamp, a serial number of the device, and a budget 808 for the device.

In an embodiment, messaging bus 824 includes one or more BMC data topics. A BMC data topic of messaging bus 824 may include characteristics (e.g., resource consumption) of compute devices that are monitored by BMCs 826 and/or other information. Information is published to a BMC data topic by BMCs 826 and/or other publishers. Information published to the BMC data topic is consumed by enforcement plane 822 and/or other consumers. An example key attached to a message published to a BMC data topic is an identifier of a leaf-level device (e.g., a rack number). The content of a message published to a BMC data topic by a BMC 826 may vary depending on the reporting parameters assigned to that BMC 826. An example message published to a BMC data topic by a BMC 826 of a host may include a serial number of the host, a serial number of the BMC 826, an activation state of the host (e.g., enabled or disabled), a current enforcement threshold 810 imposed on the host, a time window for enforcing the current enforcement threshold 810, a minimum enforcement threshold 810, a maximum enforcement threshold 810, a pending enforcement threshold 810, a power state of the host (e.g., on or off), power consumption of the host, other sensor data of the host (e.g., CPU power draw, GPU power draw, fan speeds, inlet and outlet temperatures, etc.), a firmware version of the BMC, occupancy levels (e.g., utilization levels of computer resources), health data, fault data, and/or other information.

In an embodiment, messaging bus 824 includes one or more aggregated data topics. An aggregated data topic includes messages from child controllers of enforcement plane 822 that are directed to parent controllers of enforcement plane 822. Thus, information is published to an aggregated data topic by enforcement plane 822 and/or other publishers, and information published to an aggregated data topic is consumed by enforcement plane 822 and/or other consumers. A message published to an aggregated data topic includes information pertaining to the status of a device in a data center (e.g., aggregate resource consumption of descendant devices) and/or other information that is aggregated by a controller of that device. An example key attached to a message published to an aggregated data topic is an element ID of an element in a topology 806 of a data center that represents a parent device. In general, the content of messages published to an aggregated data topic may depend on the content of messages published to a BMC data topic. An example message published to an aggregated data topic by a controller of a device may include a timestamp, an ID of the device and/or a controller of the device, an ID of a parent device and/or parent controller, an aggregate power draw of the device, an enforcement threshold 810 currently imposed on the device, a minimum enforcement threshold 810, a maximum enforcement threshold 810, a pending enforcement threshold 810, occupancy levels, health data, fault data, and/or other information.

In an embodiment, messaging bus 824 includes one or more budget enforcement topics. A budget enforcement topic includes instructions for enforcing budgets 808. Among other information, a budget enforcement topic may include enforcement thresholds 810 that are imposed on devices in a data center. Information is published to a budget enforcement topic by enforcement plane 822, urgent response loop 820, and/or other publishers. Information published to a budget enforcement topic may be consumed by enforcement plane 822, monitoring shim 828, compute control plane 818, user instance controllers, and/or other consumers. In general, the content of messages published to a budget enforcement topic may depend on the budget constraints included in a budget 808 that is being enforced, the intended enforcement mechanism for the budget 808, and other factors. An example message published to a budget enforcement topic may include a timestamp, element IDs, device serial numbers, enforcement thresholds 810, and/or other information.

In an embodiment, messaging bus 824 includes one or more user instance metadata topics. A user instance metadata topic includes metadata associated with user instances that are placed on compute devices (i.e., user instance metadata). Information is published to a user instance metadata topic by a compute control plane 818 and/or other publishers. Information published to a user instance metadata topic is consumed by control plane 816 and/or other consumers. An example message published to a user instance metadata topic includes a timestamp, an ID of a user instance, an ID of a host that the user instance is placed on, a user tenancy ID, a user priority level (e.g., low, medium, high, etc.), a cluster ID, a state of the user instance (e.g., running), and/or other information.

In an embodiment, messaging bus 824 includes one or more compute device metadata topics. A compute device metadata topic includes metadata associated with compute devices (i.e., compute device metadata). Information is published to a compute device metadata topic by a compute device metadata service 830, compute control plane 818, and/or other publishers. Information published to a compute device metadata topic is consumed by control plane 816 and/or other consumers. An example message published to a compute device metadata topic includes an ID of a host, an ID of a BMC 826 associated with the host (e.g., a serial number), an ID of a rack of hosts that includes the host, a lifecycle state of the host (e.g., pooled, in use, recycled, etc.), occupancy levels (e.g., virtualization density, schedule queue length, etc.), and/or other information.

In an embodiment, messaging bus 824 includes one or more enforcement metadata topics. An enforcement metadata topic of messaging bus 824 includes metadata that can be used as a basis for determining how to implement budgets 808 and/or enforcement thresholds 810 (referred to herein as “enforcement metadata”). Information is published to an enforcement metadata topic by control plane 816 and/or other publishers. Information published to the enforcement metadata topic is consumed by enforcement plane 822 and/or other consumers. An example key attached to a message published to an enforcement metadata topic is a serial number of a host. An example message published to an enforcement metadata topic includes a timestamp, a serial number of a host, a score assigned to a user instance placed on the host (e.g., 1-100) that indicates the importance of the user instance, a lifecycle state of the host, a user instance ID, a cluster ID, occupancy levels of the host (e.g., virtualization density, schedule queue length, etc.), and/or other information.

In an embodiment, a BMC 826 refers to software and/or hardware configured to monitor and/or manage a compute device. An example BMC 826 includes a specialized microprocessor that is embedded into the motherboard of a compute device (e.g., a host). A BMC 826 embedded into a compute device may be configured to operate independently of a main processor of the compute device, and the BMC 826 may be configured to continue operating normally even if the main processor of the compute device is powered off or functioning abnormally. A BMC is configured to communicate with other components of system 800, components external to system 800, and/or users of system 800 via messaging bus 824, API(s), and/or other means of communication. A BMC 826 may be configured to communicate with a user of system 800 via interface 832.

In an embodiment, a BMC 826 of a compute device is configured to report on the status of the compute device to enforcement plane 822 and/or other recipients. A BMC 826 of a compute device is configured to report on the status of the compute device pursuant to reporting parameters that have been defined for the BMC 826. The reporting parameters of a BMC 826 may stipulate the content of reporting by the BMC 826, the format of reporting by the BMC 826, the timing and frequency of reporting by the BMC 826, the recipients of reporting by the BMC 826, the method that reporting of the BMC 826 is to be communicated to recipients, and/or other aspects of reporting by the BMC 826. The reporting parameters of a BMC 826 may be adjusted by enforcement plane 822, another component of system 800, or a user of system 800. The reporting parameters of a BMC 826 may be adjusted dynamically by a component of system 800 to better suit changing circumstances. In an example, a BMC 826 of a host is configured to report state information of the host to a leaf-level controller in enforcement plane 822 via messaging bus 824. In this example, the leaf-level device managed by the leaf-level controller is an ancestor device of the host (e.g., a rack of hosts that includes the host), and the BMC 826 is configured to publish state information of the host to a partition of a BMC data topic corresponding to the leaf-level device.

In an embodiment, a BMC 826 of a compute device is configured to serve as a mechanism for enacting budgets 808 and enforcement thresholds 810 by limiting resource utilization of the compute device. In particular, a BMC 826 of a compute device may be configured to enact enforcement thresholds 810 imposed on that compute device. A BMC 826 may be configured to enforce an enforcement threshold 810 that includes power constraints, thermal constraints, network constraints, use constraints, and/or other types of restrictions. In an example, a BMC 826 of a host may be configured to enforce a power cap threshold imposed on the host by a leaf-level controller (e.g., a rack controller) by enacting a hard limit on the power consumption of the host that is defined by the power cap threshold. By enforcing an enforcement threshold 810 imposed on a compute device, a BMC 826 of the compute device contributes to the enforcement of budgets 808 and/or enforcement thresholds 810 assigned to ancestor devices of the compute device. A BMC 826 of a compute device may be configured to restrict the resource consumption of a particular component of the compute device. For example, a BMC 826 of a host may be configured to impose an individual cap on the power that is consumed by a GPU of the host, and/or the BMC of the host may be configured to impose an individual cap on the power that is consumed by a CPU of the host.

In an embodiment, monitoring shim 828 refers to software and/or hardware configured to (a) detect restrictions on resource utilization and (b) trigger the alerting of entities that may be impacted by the restrictions on resource utilization. Monitoring shim 828 is configured to communicate with other components of system 800, components external to system 800, and/or users of system 800 via messaging bus 824, API(s), and/or other means of communication. Monitoring shim 828 may be configured to communicate with a user of system 800 via interface 832.

In an embodiment, monitoring shim 828 is configured to (a) detect the imposition of restrictions on resource utilization imposed on devices of a data center and (b) trigger the sending of alerts to users of the data center that may be impacted by the restrictions. In an example, monitoring shim 828 is configured to monitor a budget enforcement topic of messaging bus 824 for the imposition of enforcement thresholds 810 on devices of a data center. If monitoring shim 828 identifies an enforcement threshold 810 that is being imposed on a device in this example, monitoring shim 828 is further configured to direct compute control plane 818 to alert data center users that may be impacted by the enforcement threshold 810. For instance, if an enforcement threshold 810 is imposed on a host of the data center in this example, monitoring shim 828 may instruct compute control plane 818 to alert an owner of a user instance that is placed on the host.

In an embodiment, device metadata service 830 refers to software and/or hardware configured to provide access to information associated with compute devices and/or compute workloads (i.e., compute metadata). Device metadata service 830 may expose one or more APIs that can be used to obtain compute metadata. Device metadata service 830 is configured to communicate with other components of system 800, components external to system 800, and/or users of system 800 via messaging bus 824, API(s), and/or other means of communication. Device metadata service 830 may be configured to communicate with a user of system 800 via interface 832.

In an embodiment, device metadata service 830 is configured to provide access to compute metadata that can be used as a basis for budgeting determinations. In particular, device metadata service 830 is configured to provide other components of system 800 (e.g., control plane 816, compute control plane 818, budget engine 814, etc.) access to compute device metadata. As an example, consider a host in a data center. In this example, device metadata service 830 is configured to provide access to compute device metadata of the host such as an ID of the host, a serial number of a BMC 826 associated with the host, a rack number of a rack of hosts that includes the host, a lifecycle state of the host, and/or other information. Example lifecycle states of a host include pooled, in use, recycled, and others.

In an embodiment, interface 832 refers to software and/or hardware configured to facilitate communications between a user and components of system. Interface 832 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 832 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 832 is specified in one or more other languages, such as Java, C, or C++.

In an embodiment, system 800 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, a tenant is a corporation, organization, enterprise or other entity that accesses a shared computing resource.

### 6. Dynamic Budgeting

FIG. 9 illustrates an example set of operations for dynamically updating budgeting for a network of devices in accordance with one or more embodiments. One or more operations illustrated in FIG. 9 may be modified, rearranged, or omitted. Accordingly, the particular sequence of operations illustrated in FIG. 9 should not be construed as limiting the scope of one or more embodiments. In an embodiment, techniques described herein for dynamically updating budgeting for a network of devices are applied to devices of a data center; to provide consistent examples, the remainder of this Section 6 shall assume the same.

In an embodiment, the system monitors the operating conditions of a data center (Operation 902). In particular, the system monitors the data center for changes to inputs that are a basis for budget generation. Example operating conditions that may be monitored by the system include topological characteristics of the data center, characteristics of devices included in the data center, atmospheric conditions inside the data center, atmospheric conditions external to the data center, external limitations imposed on the data center, activity of data center operators, activity of data center users, historical patterns of activity regarding the data center, and other information that is relevant to budgeting for the data center.

In an embodiment, the system detects the presence of new devices in the data center while monitoring the topological characteristics of the data center, and/or the system detects the absence of devices previously detected in the data center while monitoring topological characteristics of the data center. The system may detect the presence and/or absence of compute devices, energy distribution devices, atmospheric regulation devices, and/or other types of devices. The system may detect the presence and/or absence of devices in the data center through various mechanisms such as network discovery protocols, IP address scanning, MAC address tables, physical layer connectivity, device-specific discovery mechanisms, asset management systems, user input from data center operators, and/or other mechanisms.

In an embodiment, the system determines characteristics of a new device that are relevant to budgeting upon detecting the presence of the new device in the data center. As an example, assume that the system detects a new host in the data center (e.g., a CPU server, a GPU chassis, etc.). In this example, the system determines specifications of the host such as network capabilities of the host, power supply unit efficiency ratings, thermal design power ratings, cooling requirements, chassis type and size, and/or other characteristics. As another example, assume that the system identifies a new circuit breaker in an electricity distribution network of the data center. In this other example, the system may determine the trip settings of the circuit breaker (e.g., a rated current, a time delay, etc.), devices whose power draw is directly or indirectly restricted by the circuit breaker, and/or other characteristics.

In an embodiment, the system determines topological relationships of a new device in the data center upon detecting the presence of the new device in the data center. For instance, the system may determine how electricity is supplied to and/or distributed from the new device. Examples of topological relationships between devices that may be detected by the system include power cables, network pathways, spatial proximity, shared atmospheric regulation devices, and other relationships. As an example, assume that the system detects the presence of a new rack of hosts in the data center. In this example, the system may determine (a) that under normal operating conditions an rPDU in the new rack of hosts is distributed electricity from a busway, (b) that the busway is distributed electricity from a PDU, and (c) that the PDU is distributed electricity from a UPS. Additionally, the system of this example may identify any additional connections that are built into the electricity distribution network of the data center for purposes of redundancy (e.g., the new rack of hosts may include an additional rPDU, the additional rPDU may be connected to an alternative busway, the alternative busway may be connected to an alternative PDU, etc.). Additionally, or alternatively, the system of this example determines other topological relationships of the new rack of hosts. For instance, the system of this example may identify an atmospheric regulation device that is responsible for regulating atmospheric conditions in a room of the data center that includes the new rack of hosts. The system of this example may evaluate whether the capabilities of the atmospheric regulation device will be sufficient to adequately regulate atmospheric conditions in the room of the data center following the addition of the new rack of hosts, and this evaluation may inform determinations by the system regarding if and how budgets of other devices in the room of the data center should be updated following the addition of the new rack of hosts.

In an embodiment, the system detects changes to the topological relationships between devices in the data center while monitoring topological characteristics of the data center. For instance, the system may detect if a device in the data center has been connected to a new parent device, and/or the system may detect if a device in the data center has been connected to a new child device. Furthermore, the system may determine if a device in the data center is having to rely on a backup parent device for resources (e.g., electricity) that are normally supplied to the device by another parent device during normal operating conditions of the data center.

In an embodiment, the system monitors characteristics of individual devices in the data center. The system may monitor the individual characteristics of compute devices, virtual devices, power infrastructure devices, atmospheric regulation devices, network infrastructure devices, security devices, monitoring and management devices, and other devices that support the operation of a data center. General examples of characteristics of a device that may be monitored by the system include the health of the device, the resources that are being utilized by the device, the utilization of the device's resources, the temperature of the device, and other characteristics.

In an embodiment, the system monitors the health of physical devices in the data center for signs of deterioration. For instance, the system may monitor the health of a device for signs of a failure of the device, a partial failure of the device, and/or a gradual reduction in the device's capabilities over time. In an example, the system detects the failure or imminent failure of a power infrastructure device in the data center (e.g., a UPS, a PDU, a busway, an rPDU, etc.), an atmospheric regulation device in the data center (e.g., a chiller, an HVAC system, etc.), a compute device in the data center (e.g., a host), or another type of device in the data center.

In an embodiment, the system monitors external limitations imposed on the data center for changes that may warrant updating budgeting for the data center. Example external limitations that may be monitored by the system include government restrictions, the cost and availability of electricity supplied to the data center, functionality of a local power grid, fluctuations in electricity supply from renewable energy sources (e.g., solar, wind, etc.), the cost and availability of fuel supplied to the data center, the cost and availability of water supplied to the data center for cooling systems, and other external limitations.

In an embodiment, the system monitors atmospheric conditions of the data center for changes that may warrant updating budgeting for the data center. The system monitors atmospheric conditions within the data center, and/or the system monitors atmospheric conditions external to the data center. General examples of atmospheric conditions that may be monitored by the system include temperature, pressure, humidity, air quality, present weather events, forecasted weather events, and other atmospheric conditions. The system monitors atmospheric conditions of the data center via atmospheric sensors within the data center, atmospheric sensors external to the data center, and/or other sources of information. Additionally, or alternatively, the system monitors weather forecasts for a geographical region that includes the data center for forecasted atmospheric conditions that could potentially impact the operation of the data center.

In an embodiment, the system determines or estimates the resources that are being utilized by devices whose resource consumption is not independently monitored by the system. For example, the system may determine or estimate the power that is drawn by devices of the data center whose power draw is not independently monitored by the system. Depending on the characteristics of the data center, the power that is drawn by these other devices may be significant, and a change in the power draw of these devices may warrant updating budgeting for the data center. The devices whose power draw is not independently monitored by the system may coincide with devices of the data center that are not distributed electricity through a portion of the data center's electricity distribution network that is represented in a topology of the data center. Devices of the data center whose power draw is not being actively monitored by the system may include compute devices, virtual devices, power infrastructure devices, atmospheric regulation devices, network infrastructure devices, security devices, monitoring and management devices, and other types of devices. Examples of devices whose power draw it may be impractical or undesirable to independently monitor include appliances (e.g., refrigerators, microwaves, etc.), personal devices (e.g., phones, laptops, etc.), chargers for personal devices, electric vehicles charging from an electricity outlet of a data center, HVAC systems for workspaces of data center operators, and various other devices.

In an embodiment, the system determines if a topology of the data center should be updated, and the system proceeds to another operation based on the determination (Operation 904). The system may conclude that a topology of the data center should be updated if changes to topological characteristics of the data center have been detected. Examples of changes to topological characteristics of the data center that may warrant updating a data center topology include the presence of a newly-detected device in the data center, the absence of a previously-detected device in the data center, a change in the manner that resources (e.g., electricity, coolant, etc.) are distributed to a device in the data center, a change to the location of a device in the data center, a change to the devices whose atmosphere is being regulated by an atmospheric regulation device, a change in network pathways between devices in the data center, and various other topological changes. If the system determines that a topology of the data center should be updated (YES at Operation 904), the system proceeds to Operation 906. If the system maintains multiple topologies of the data center, the system may determine that a single data center topology should be updated, or the system may determine that multiple data center topologies should be updated. Alternatively, if the system determines that no updates to a data center topology are warranted at this time (NO at Operation 904), the system proceeds to Operation 908.

In an embodiment, the system updates a topology of the data center (Operation 906). The system updates a single data center topology, or the system updates multiple data center topologies. If the system updates multiple topologies of the data center, the multiple topologies may reflect different topological characteristics of the data center and/or different parts of the data center (e.g., different rooms). A topology of the data center may be updated to (a) include newly detected devices in the data center, (b) exclude previously-detected devices in the data center, (c) reflect changes in the way that resources are distributed to devices in the data center, and/or (d) reflect other changes to other topological characteristics of the data center. An example topology of a data center represents devices such as hosts, racks of hosts, busways, PDUs, UPSs, and/or other devices. Furthermore, the example topology represents parent-child relationships of the devices represented in the topology, and the parent-child relationships between the devices reflect an electricity distribution network of the data center. Additional embodiments and/or examples relating to a data center topology are described below in Section 7 titled “Example Embodiment.”

In an embodiment, the system determines if budgeting for the data center should be updated, and the system proceeds to another operation based on the determination (Operation 908). To determine if budgeting for the data center should be updated, the system analyzes the operating conditions of the data center. In general, the system may conclude that budgeting for the data center should be updated if the system detects or predicts a change in the operating conditions of the data center that potentially impacts the operation of the data center. If the system determines that budgeting for the data center should be updated (YES at Operation 908), the system proceeds to Operation 910. Alternatively, if the system determines that budgeting for the data center should not be updated (NO at Operation 908), the system returns to Operation 902. In an example, the system concludes that budgeting for the data center should be updated because the system determines that a budget assigned to a device in the data center is presently inadequate for the current operating conditions of the data center. In another example, the system concludes that budgeting for the data center should be updated because the system determines that a budget assigned to a device in the data center is inadequate for the expected operating conditions of the data center in the future.

In an embodiment, the system concludes that budgeting for the data center should be updated because a new topology for the data center has been generated. The new data center topology has been generated in response to a change to the data center's topological characteristics. For example, it may be that the system detected the presence of a new device in the data center, the absence of a previously-detected device in the data center, a change in the manner that resources (e.g., electricity) are distributed to a device in the data center, and/or other changes to the data center's topological characteristics.

In an embodiment, the system concludes that budgeting for the data center should be updated based on an observed change to the characteristics of a device or devices in the data center. For instance, the system may conclude that budgeting for the data center should be updated based on a change to the health of a device, the capabilities of a device, the utilization of resources by a device, the utilization of a device's resources, the temperature of a device, and/or various other characteristics of a device. In an example, the system observes a rise in the temperature of a device in the data center, and the system concludes that a budget assigned to the device should be updated to counter the rising temperature of the device.

In an embodiment, the system concludes that budgeting for the data center should be updated based on identifying a deterioration in the health of a device in the data center. For instance, the system may conclude that budgeting for the data center should be updated based on an observed deterioration in the capabilities of a compute device, a power infrastructure device, an atmospheric regulation device, a network infrastructure device, or another device that support the operation of the data center. As an example, assume that the system observes a failure or partial failure of a power infrastructure device. In this example, the system may conclude that updates should be applied to budgeting for the power infrastructure device, parent devices of the power infrastructure device, child devices of the power infrastructure device, back up parent devices for the child devices of the power infrastructure device, sibling devices of the power infrastructure devices, and/or other devices. As another example, assume that system observes a failure or partial failure of an atmospheric regulation device that is intended to regulate the temperature of a room in the data center. In this example, the system may conclude that budgeting for devices in that room of the data center should be updated to lower the heat output of those devices to compensate for the reduced capabilities of the atmospheric regulation device.

In an embodiment, the system determines that budgeting for the data center should be updated based on a predicted occurrence that may impact the data center. The predicted occurrence may be determined by the system, or the predicted occurrence may be obtained from a source of information external to the system. In an example, the system determines that an update to budgeting for the data center is warranted based on forecasted atmospheric conditions in a region where the data center is located (e.g., an expected temperature change, a forecasted weather event, etc.). In another example, the system determines that an update to budgeting for the data center is warranted based on planned maintenance for a device in the data center. In yet another example, the system determines that an update to budgeting for the data center is warranted based on the system predicting that a device in the data center will fail. The system may predict an occurrence by applying a trained machine learning model to the observed operating conditions of the data center. For example, the system may predict the failure of a device in the data center based on applying a trained machine learning model to the characteristics of the device and/or other operating conditions of the data center.

In an embodiment, the system determines that budgeting for the data center should be updated based on atmospheric conditions within the data center and/or atmospheric conditions external to the data center. In an example, the system concludes that budgeting for the data center should be updated based on temperature measurements that meet or exceed temperature thresholds. In this example, a temperature measurement that meets or exceeds a temperature threshold measures a temperature external to the data center, or the temperature measurement that meets or exceeds the temperature threshold measures a temperature internal to the data center.

In an embodiment, the system generates updated budget(s) for device(s) in the data center (Operation 910). The system generates updated budgets for child devices in the data center, and/or the system generates updated budgets for parent devices in the data center. As an example, assume that (a) a UPS distributes electricity to multiple PDUs, (b) the multiple PDUs distribute electricity to multiple busways, and (c) the multiple busways distribute electricity to multiple racks of hosts. In this example, the system may generate updated budgets for the UPS, PDUs, busways, racks of hosts, and/or hosts. The devices of a data center that are assigned budgets may vary between applications. In general, the devices of a data center that are assigned budgets may depend on the size of the data center, the number of devices in the data center, the typical operating conditions of the data center, the characteristics of devices in the data center, and/or various other factors. Example inputs that may be a basis for generating an updated budget for a device include a topology of the data center, budgets assigned to other devices that are related to the device, characteristics of devices in the data center, external limitations imposed on the data center, (e.g., government restrictions, the cost of electricity supplied to the data center, functionality of a local power grid, etc.), internal and/or external atmospheric conditions of the data center (e.g., temperature, humidity, forecasted weather events, etc.), estimated power draw of devices not represented in the topology of the data center, input from data center operators, and other operating conditions of the data center.

In an embodiment, the system generates a budget for a device in the data center based, at least in part, on budgets that are assigned to other related devices in the data center. For example, the system may generate a budget for a device in the data center based on a budget assigned to a parent device of the device, a budget assigned to a child device of the device, a budget assigned to a sibling device of the device, and/or budgets assigned to other ancestor devices or descendant devices. An update to one budget may trigger an update to another budget. For example, an update to a budget of a device may trigger an update to the respective budgets of ancestor devices of the device, sibling devices of the device, and/or descendant devices of the device.

In an embodiment, the system generates updated budgets for devices in the data center based on a change to topological characteristics of the data center. For instance, if the system detects the presence of a new device in the data center, the system may generate a new budget for that device (e.g., if the device is a leaf-level device or an ancestor of a leaf-level device). Additionally, or alternatively, if the system detects the presence of a new device in the data center, the system may update the budgets of other devices that are related to that device. In an example, the system detects a new rack of hosts in the data center, and the system generates a new budget for the new rack of hosts. Furthermore, in this example, the system may update the budgets assigned to sibling devices of the new rack of hosts (e.g., other racks of hosts that are distributed electricity through the same busway), and/or the system may update a budget assigned to ancestor devices of the new rack of hosts (e.g., a busway, a PDU, a UPS, etc.).

In an embodiment, the system generates updated budgets for devices in the data center based on a deterioration in the health of a device in the data center. For example, if the system detects a failure of a power infrastructure device the system may update budgeting for the data center to redistribute electricity that was formerly allocated to the failed power infrastructure device to backup parent devices of the child devices of the failed power infrastructure device. Furthermore, in this example, the budgeting for the child devices of the failed power infrastructure device and the budgeting for the child devices of the backup parent devices may also be updated to ensure that the additional load on the backup parent devices does not exceed any hardware and/or software limitations of the backup parent devices (e.g., a trip threshold of a circuit breaker incorporated into a backup parent device). As another example, assume that the system detects the failure of an atmospheric regulation device in the data center. In this other example, the system may identify devices in the data center that are included in an environment that was formerly being regulated by the failed atmospheric regulation device, and the system may adjust the budgeting for those devices to compensate for the failure of the atmospheric regulation device. For instance, if the failed atmospheric regulation device is an in-row cooling system that formerly regulated the heat output of a rack of hosts, the system may adjust the budget for that rack of hosts to reduce the heat output of the hosts that are included in the rack in this other example.

In an embodiment, the system generates updated budgets for devices in the data center based on a change in atmospheric conditions of the data center. For example, if the system observes a rise in temperature in a room of the data center, the system may update budgeting for devices in that room of the data center to reduce the heat output of those devices. In this example, the system may reduce the heat output of those devices by updating power constraints, thermal constraints, use constraints, or other types of budget constraints that are applicable to those devices.

In an embodiment, the system generates updated budgets for devices in the data center based on a predicted change to operating conditions of the data center. The system generates updated budgets that are to be applied preemptively. For instance, an updated budget may be intended to prevent or mitigate the impact of a predicted change to the operating conditions of the data center. Additionally, or alternatively, the system generates conditional budgets that are to be applied in the event of a predicted change to operating conditions of the data center occurring. In an example, the system generates updated budgets based on a forecasted heat wave that is expected to occur in a geographical region that includes the data center. In this example, the updated budgets may be intended for preemptive application to compensate for the onset of the forecasted heatwave, and/or the updated budgets may include conditional budgets that are to be applied in the event of the heat wave causing an internal and/or external temperatures of the data center to rise above threshold temperatures. In another example, the system generates updated budgets based on a predicted failure of a device in the data center. In this other example, the updated budgets may include budgets that are to be applied preemptively in attempt to prevent the predicted failure from occurring or to mitigate the impact of the predicted failure, and/or the updated budgets may include conditional budgets that are to be applied in the event of the predicted failure actually occurring.

In an embodiment, the system generates budgets for the data center by applying a trained machine learning model to the operating conditions of the data center. The machine learning model may be trained using a machine learning algorithm and sets of training data. An example set of training data defines an association between individual budgets in the data center and the topology, operating conditions, limitations, seasonality factors, power draw of non-infrastructure components, and/or other characteristics of the data center. The system may receive feedback pertaining to budgets generated by the machine learning model, and the machine learning model may be further trained based on the feedback.

In an embodiment, the system communicates the updated budget(s) to the appropriate enforcement mechanism(s) for those budget(s) (Operation 912). In an example, updated budgets are communicated from a budget engine to a control plane, and the control plane distributes the updated budgets to controllers in an enforcement plane that are configured to manage the devices corresponding to the updated budgets. The control plane of this example distributes the updated budgets to the controllers by publishing the updated budgets to a budgets topic of a messaging bus. In this example, one or more consumers of the budgets topic retrieve the updated budgets from the budgets topic and store the updated budgets to caches of the enforcement plane where the updated budgets can be retrieved by the controllers. The controllers of this example subsequently retrieve the budgets from the caches, and the controllers monitor the state of the controller's respective devices with respect to the budget constraints defined in the updated budgets. The controllers of this example may subsequently determine enforcement thresholds that are used to implement budget constraints of the updated budgets. In this example, the enforcement thresholds may subsequently be enacted by BMCs of compute devices, a compute control plane, user instance controllers, enforcement agents operating on computer systems of data center users, and/or other enforcement mechanisms of the system. In another example, the updated budgets include conditional budgets. The conditional budgets of this other example may have been generated by the system in response to a predicted change in the operating conditions of the data center. For instance, the conditional budgets may have been generated based on a forecast in a geographical region external to the data center, a predicted failure of a device, a predicted change to workloads imposed on devices in the data center, or some other predicted occurrence. In this other example, an urgent response loop is configured to monitor the operating conditions of the data center for the trigger conditions associated with the conditional budgets. If the urgent response loop of this other example subsequently detects the presence of one or more trigger conditions associated with the conditional budgets (e.g., the occurrence of a predicted change to the operating conditions of the data center), the urgent response loop will transmit the conditional budgets to the corresponding controllers in an enforcement plane.

### 7. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

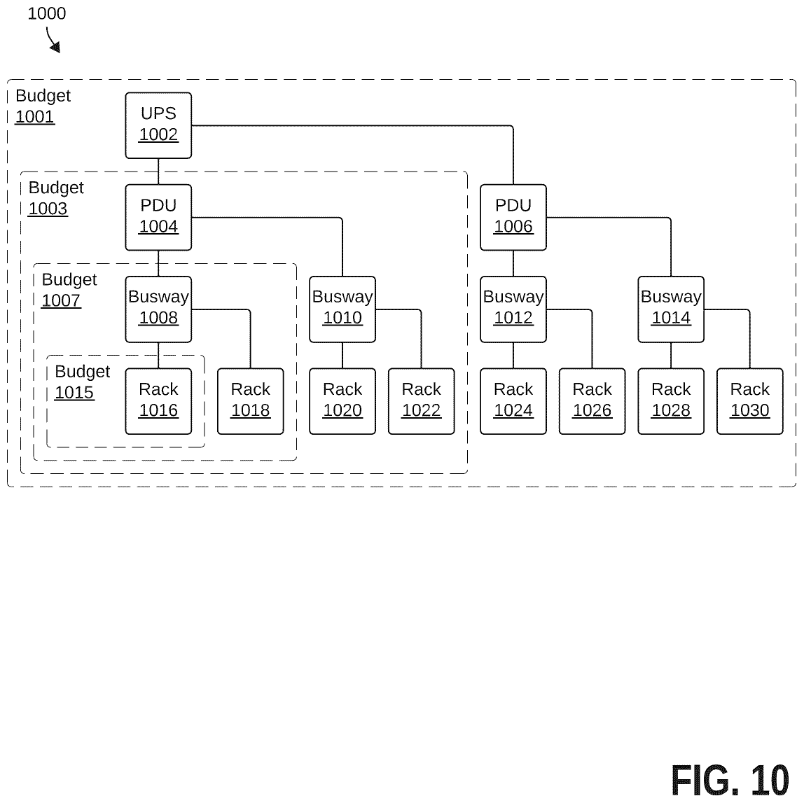

FIG. 10 is a visualization of a data center topology 1000 according to an example embodiment. To provide clear examples, topology 1000 represents a simplified example of a data center. In the example illustrated by FIG. 10, the elements included in topology 1000 represent physical devices in the simplified example data center. As illustrated by FIG. 10, topology 1000 includes elements representing UPS 1002, PDU 1004, PDU 1006, busway 1008, busway 1010, busway 1012, busway 1014, rack 1016, rack 1018, rack 1020, rack 1022, rack 1024, rack 1026, rack 1028, and rack 1030. In one or more embodiments, a topology 1000 includes more or fewer elements than the elements illustrated in FIG. 10, and/or a topology 1000 includes elements representing other types of devices than those devices represented in FIG. 10. The links between the elements illustrated in FIG. 10 represent electrical connections that make up a portion of an electricity distribution network in the simplified example data center. The electrical connections represented in FIG. 10 are electrical connections that are used to distribute electricity in normal operating conditions of the simplified example data center. It should be noted that any redundant electrical connections in the simplified example data center linking child devices to backup parent devices are not illustrated in FIG. 10. In one or more embodiments, a topology 1000 represents relationships between devices other than the electrical connections that make up an electricity distribution network of a data center.

In an example embodiment, a budget engine of the system determines one or more updated budgets for one or more of the devices included in the simplified example data center that are represented in topology 1000 as illustrated by FIG. 10. In particular, budget engine determines updated budgets for one or more of UPS 1002, PDU 1004, PDU 1006, busway 1008, busway 1010, busway 1012, busway 1014, rack 1016, rack 1018, rack 1020, rack 1022, rack 1024, rack 1026, rack 1028, and/or rack 1030. The budget engine generates the updated budgets based on the operating conditions of the simplified example data center. FIG. 10 illustrates a subset of the budgets that are assigned to individual devices represented in topology 1000 (i.e., budget 1001, budget 1003, budget 1007, and budget 1015). Additionally, or alternatively, the budget engine generates the updated budgets based on other budgets for other devices. For instance, budget engine may determine an update to budget 1007 based on budget 1003, budget 1015, budgets assigned to busway 1010 and/or rack 1018 (i.e., budgets not illustrated in FIG. 10), and/or other budgets. The updated budgets are retrieved from the budget engine by a control plane of the system, and the control plane communicates the updated budgets to an enforcement plane of the system. In particular, the control plane communicates the updated budgets to controllers in the enforcement plane that were spawned to manage the devices corresponding to the updated budgets. For instance, if budget 1001 is a budget updated by the budget engine, the control plane communicates budget 1001 to a controller of UPS 1002. The control plane communicates the updated budgets to the controllers by publishing the updated budgets to a budgets topic maintained by a messaging bus of the system.

In an example embodiment, budget 1001 is assigned to UPS 1002. Budget 1001 includes one or more budget constraints that limit the power that may be drawn by UPS 1002 from one or more sources of electricity that are not illustrated in FIG. 10. For example, budget 1001 may allocate a maximum instantaneous power draw of UPS 1002, and/or a maximum average power draw of UPS 1002. By limiting the power that can be drawn by UPS 1002, budget 1001 indirectly restricts the aggregate power that can be consumed by the descendant devices of UPS 1002 (e.g., hosts in racks of hosts that are distributed electricity originating from UPS 1002). Additionally, or alternatively, budget 1001 includes other budget constraints such as thermal constraints, network constraints, and/or other types of budget constraints. An example thermal constraint that may be included in budget 1001 indirectly limits the amount of heat that can be created by the descendant devices of UPS 1002 and/or the amount of coolant that can be consumed by the descendant devices of UPS 1002. An example network constraint that may be included in budget 1001 indirectly limits the amount of bandwidth that can be utilized by descendant devices of UPS 1002. Budgeting in the simplified example data center may provide for the oversubscription of devices. As a result, an allocation of a resource to a parent device may be less than the sum of the allocations of that resource to child devices. For example, a maximum permissible power draw allocated to UPS 1002 by budget 1001 may be less than the sum of a maximum permissible power draw allocated to PDU 1004 by budget 1003 and a maximum permissible power draw allocated to PDU 1006 by a budget of PDU 1006. An update to budget 1001 may trigger an update to other budgets assigned to other devices in the simplified example data center. For instance, if budget 1001 is updated to contain a more stringent budget constraint, budget 1003 and a budget assigned to budget PDU 1006 may also be updated to include more stringent budget constraints. Budget 1001 may be updated to reflect a change in operating conditions that impacts the devices illustrated in FIG. 10. For instance, budget 1001 may be updated to reflect a change to atmospheric conditions in a room that includes the devices illustrated in FIG. 10, a change to an external limitation imposed on the simplified example data center, a change to atmospheric conditions external to the simplified example data center, and/or changes to other operating conditions that impact devices illustrated in FIG. 10.

In an example embodiment, UPS 1002 is an uninterruptable power source configured to distribute electricity to PDU 1004 and PDU 1006. In other words, UPS 1002 is a parent device to PDU 1004 and PDU 1006. Additionally, UPS 1002 may be configured to act as a backup parent device to other devices in the simplified example data center that are not illustrated in FIG. 10 (e.g., other PDUs). UPS 1002 is managed by a controller spawned in an enforcement plane of the system. The controller of UPS 1002 monitors the state of UPS 1002. The controller of UPS 1002 may be configured to monitor the state of UPS 1002 by aggregating information (e.g., power measurements) reported to the controller of UPS 1002 by controllers of PDU 1004 and PDU 1006. Furthermore, the controller of UPS 1002 is configured to implement budgets assigned to UPS 1002, and the controller of UPS 1002 is configured to implement enforcement thresholds assigned to UPS 1002. The controller of UPS 1002 may implement a budget constraint and/or enforcement threshold of UPS 1002 by imposing enforcement thresholds on child devices of UPS 1002. For instance, the controller of UPS 1002 may implement a power constraint of budget 1001 by imposing enforcement thresholds on PDU 1004 and/or PDU 1006. Ultimately, a budget constraint of budget 1001 is enacted by limiting the resource utilization of the hosts that are included in rack 1016, rack 1018, rack 1020, rack 1022, rack 1024, rack 1026, rack 1028, and rack 1030.

In an example embodiment, budget 1003 is assigned to PDU 1004. Budget 1003 includes one or more budget constraints that limit the power that may be drawn by PDU 1004 from UPS 1002. By limiting the power that can be drawn by PDU 1004, budget 1003 indirectly restricts the aggregate power that may be consumed by the descendant devices of PDU 1004. Additionally, or alternatively, budget 1003 includes other budget constraints such as thermal constraints, network constraints, and/or other types of budget constraints. Budget 1003 may be updated in response to an update to a budget of a device that is related to PDU 1004 (e.g., UPS 1002, UPS 1006, busway 1008, busway 1010, etc.). Additionally, or alternatively, budget 1003 may be updated to reflect a change in operating conditions that is localized to PDU 1004, busway 1008, busway 1010, rack 1016, rack 1018, rack 1020, and/or rack 1022. For instance, if PDU 1004 and the ancestor devices of PDU 1004 are supported by the same atmospheric regulation device, and if that atmospheric regulation device shows signs of deteriorating health, budget 1003 may be updated to reduce the heat output of PDU 1004 and the ancestor devices of PDU 1004 (most notably the heat output from the hosts in rack 1016, rack 1018, rack 1020, and rack 1022).

In an example embodiment, PDU 1004 is a power distribution unit configured to distribute electricity to busway 1008 and busway 1010. In other words, PDU 1004 is a parent device to busway 1008 and busway 1010. Additionally, PDU 1004 may be configured to act a backup parent device to one or more other devices in the simplified example data center (e.g., busway 1012 and busway 1014). PDU 1004 is managed by a controller spawned in the enforcement plane of the system. The controller of PDU 1004 monitors the state of PDU 1004. The controller of PDU 1004 is configured to monitor the status of PDU 1004 by aggregating information reported to the controller of PDU 1004 by a controller of busway 1008 and a controller of busway 1010. The controller of PDU 1004 reports state information of PDU 1004 (e.g., recorded power draw) to the controller of UPS 1002. Furthermore, the controller of PDU 1004 is configured to implement budgets assigned to PDU 1004, and the controller of PDU 1004 is configured to implement enforcement thresholds imposed on PDU 1004. The controller of PDU 1004 may implement a budget constraint assigned to PDU 1004 and/or an enforcement threshold imposed on PDU 1004 by imposing enforcement thresholds on child devices of PDU 1004. For instance, the controller of PDU 1004 may implement a power constraint of budget 1003 by imposing power cap thresholds on busway 1008 and/or busway 1010. Ultimately, a budget constraint of budget 1003 is enforced by limiting resource utilization of hosts that are included in rack 1016, rack 1018, rack 1020, and rack 1022.

In an example embodiment, PDU 1006 is a power distribution unit configured to distribute electricity to busway 1012 and busway 1014. In other words, PDU 1006 is a parent device to busway 1012 and busway 1014. Additionally, PDU 1006 may be configured to act as a backup parent device to other devices in the data center (e.g., busway 1008 and busway 1010). PDU 1006 is managed by a controller spawned in the enforcement plane of the system. The controller of PDU 1006 monitors the state of PDU 1006 (e.g., by aggregating state information of busway 1012 and busway 1014), and the controller of PDU 1006 reports state information of PDU 1006 to the controller of UPS 1002. The controller of PDU 1006 may implement a budget constraint assigned to PDU 1006 and/or an enforcement threshold imposed on PDU 1006 by imposing enforcement thresholds on busway 1012 and/or busway 1014.

In an example embodiment, budget 1007 is assigned to busway 1008. Budget 1007 includes one or more budget constraints that limit the power that may be drawn by busway 1008 from PDU 1004. By limiting the power that can be drawn by busway 1008, budget 1007 indirectly restricts the aggregate power that may be consumed by the descendant devices of busway 1008. Additionally, or alternatively, budget 1007 may include other budget constraints such as thermal constraints, network constraints, and/or other types of budget constraints. Ultimately, a budget constraint of budget 1007 is enforced by limiting the activity of hosts included in rack 1016 and rack 1018. Budget 1007 may be updated in response to an update to a budget of a device related to busway 1008 (e.g., PDU 1004, busway 1010, rack 1016, rack 1018, etc.). Additionally, or alternatively, budget 1007 may be updated in response to a change in operating conditions that is localized to busway 1008, rack 1016, and/or rack 1018.

In an example embodiment, busway 1008 is a busway configured to distribute electricity to rack 1016 and rack 1018. In other words, busway 1008 is a parent device to rack 1016 and rack 1018. Additionally, busway 1008 may be configured to serve as a backup parent device to other devices in the simplified example data center (e.g., rack 1020, rack 1022, rack 1024, etc.). Busway 1008 is managed by a controller spawned in the enforcement plane of the system. The controller of busway 1008 monitors the state of busway 1008 (e.g., by aggregating state information of rack 1016 and rack 1018), and the controller of busway 1008 reports state information of busway 1008 to the controller of PDU 1004. The controller of busway 1008 is configured to implement budgets assigned to busway 1008, and the controller of busway 1008 is configured to implement enforcement thresholds assigned to busway 1008. The controller of busway 1008 may implement a budget constraint assigned to busway 1008 and/or an enforcement threshold imposed on busway 1008 by imposing enforcement thresholds on rack 1016 and/or rack 1018.

In an example embodiment, busway 1010 is a busway configured to distribute electricity to rack 1020 and rack 1022. In other words, busway 1010 is a parent device to rack 1020 and rack 1022. Additionally, busway 1010 may be configured to serve as a backup parent device to other devices in the data center (e.g., rack 1016, rack 1018, rack 1024, etc.). Busway 1010 is managed by a controller spawned in the enforcement plane of the system. The controller of busway 1010 monitors the state of busway 1010, and the controller of busway 1010 reports the state of busway 1010 to the controller of PDU 1004. The controller of busway 1010 may implement a budget constraint assigned to busway 1010 and/or an enforcement threshold imposed on busway 1010 by imposing enforcement thresholds on rack 1020 and/or rack 1022.

In an example embodiment, busway 1012 is a busway configured to distribute electricity to rack 1024 and rack 1026. In other words, busway 1012 is a parent device to rack 1024 and rack 1026. Additionally, busway 1012 may be configured to serve as a backup parent device to other devices in the data center (e.g., rack 1020, rack 1022, rack 1028, etc.). Busway 1012 is managed by a controller spawned in the enforcement plane of the system. The controller of busway 1012 monitors the state of busway 1012, and the controller of busway 1012 reports the state of busway 1012 to the controller of PDU 1006. The controller of busway 1012 may implement a budget constraint assigned to busway 1012 and/or an enforcement threshold imposed on busway 1012 by imposing enforcement thresholds on rack 1024 and/or rack 1026.

In an example embodiment, busway 1014 is a busway configured to distribute electricity to rack 1028 and rack 1030. In other words, busway 1014 is a parent device to rack 1028 and rack 1030. Additionally, busway 1014 may be configured to act as a backup parent device to other devices in the data center (e.g., rack 1022, rack 1024, rack 1026, etc.). Busway 1014 is managed by a controller spawned in the enforcement plane of the system. The controller of busway 1014 monitors the state of busway 1014, and the controller of busway 1014 reports the state of busway 1014 to the controller of PDU 1006. The controller of busway 1014 may implement a budget constraint assigned to busway 1014 and/or an enforcement threshold imposed on busway 1014 by imposing enforcement thresholds on rack 1028 and/or rack 1030.

In an example embodiment, budget 1015 is assigned to rack 1016. Budget 1015 includes one or more budget constraints that limit the power that may be drawn by rack 1016 from busway 1008. By limiting the power that can be drawn by rack 1016, budget 1015 indirectly restricts the aggregate power that can be consumed by the hosts included in rack 1016. Additionally, or alternatively, budget 1015 may include other budget constraints such as thermal constraints, network constraints, and/or other types of budget constraints. Ultimately, a budget constraint of budget 1015 is enforced by limiting the activity of the hosts included in rack 1016. Budget 1015 may be updated in response to an update to a budget of a device related to rack 1016 (e.g., busway 1008, rack 1018, etc.). Additionally, or alternatively, budget 1015 may be updated to reflect a change in operating conditions that is localized to rack 1016. For instance, if a sudden increase in temperature is observed in the environment including rack 1016, budget 1015 may be updated to reduce the heat output from the hosts included in rack 1016.

In an example embodiment, rack 1016 is a rack of hosts that includes one or more rPDUs configured to distribute electricity to the hosts in rack 1016. In other words, rack 1016 is a parent device to the hosts included in rack 1016. If rack 1016 includes multiple rPDUs, an rPDU in rack 1016 may be configured to serve as (a) a primary source of electricity for a subset of the hosts included in the rack 1016 and (b) a backup source of electricity for another subset of the hosts included in rack 1016. Rack 1016 is managed by a controller spawned in the enforcement plane of the system. The controller of rack 1016 is a leaf-level controller because the controller of rack 1016 is a lowest-level controller in the hierarchy of controllers that are spawned in the enforcement to manage the devices represented in topology 1000 as illustrated by FIG. 10. The controller of rack 1016 monitors the state of rack 1016, and the controller of rack 1016 reports state information of rack 1016 to the controller of busway 1008. The controller of rack 1016 is configured to monitor the state of rack 1016 by aggregating information that is reported to the controller of rack 1016 by BMCs of the hosts that are included in rack 1016. The controller of rack 1016 communicates with the controller of busway 1008 and the BMCs of the hosts included in rack 1016 via the messaging bus. The controller of rack 1016 is configured to implement budgets assigned to rack 1016, and the controller of rack 1016 is configured to implement enforcement thresholds imposed on rack 1016. The controller of rack 1016 may implement a budget constraint assigned to rack 1016 and/or an enforcement threshold imposed on rack 1016 by imposing enforcement thresholds on child devices. For instance, the controller of rack 1016 may implement a budget constraint of budget 1015 by imposing enforcement thresholds on the hosts included in rack 1016. The controller of rack 1016 may determine enforcement thresholds for the hosts included in rack 1016 based on enforcement metadata and/or other information that is obtained by the controller of rack 1016 from a control plane of the system via the messaging bus. The control plane of the system obtains and/or generates the enforcement metadata based on compute metadata that is obtained by the control plane from a compute control plane of the system and/or a device metadata service of the system. An enforcement threshold that is imposed on a host included in rack 1016 may be enforced by directing a BMC of that host to limit the power consumption of the host, by closing the host to placement of user instances, by directing a user instance controller residing in a hypervisor layer of the host to limit the activity of user instances placed on the host, by directing an enforcement agent executing on a computing system of a user associated with a user instance placed on the host to restrict the activity of the user instance, and/or by other enforcement mechanisms.

In an example embodiment, rack 1018 is a rack of hosts that includes one or more rPDUs configured to distribute electricity to the hosts in rack 1018. In other words, rack 1018 is a parent device to the hosts included in rack 1018. If rack 1018 includes multiple rPDUs, an rPDU in rack 1018 may be configured to serve as (a) a source of electricity for a subset of the hosts in the rack 1018 and (b) a backup source of electricity for another subset of the hosts in rack 1018. Rack 1018 is managed by a leaf-level controller spawned in the enforcement plane of the system. The controller of rack 1018 monitors the state of rack 1018, and the controller of rack 1018 reports the state of rack 1018 to the controller of busway 1008. The controller of rack 1018 may implement a budget constraint assigned to rack 1018 and/or an enforcement threshold imposed on rack 1018 by imposing enforcement thresholds on the hosts included in rack 1018.

In an example embodiment, rack 1020 is a rack of hosts that includes one or more rPDUs configured to distribute electricity to the hosts in rack 1020. In other words, rack 1020 is a parent device to the hosts included in rack 1020. If rack 1020 includes multiple rPDUs, an rPDU in rack 1020 may be configured to serve as (a) a source of electricity for a subset of the hosts in the rack 1020 and (b) a backup source of electricity for another subset of the hosts in rack 1020. Rack 1020 is managed by a leaf-level controller spawned in the enforcement plane of the system. The controller of rack 1020 monitors the state of rack 1020, and the controller of rack 1020 reports the state of rack 1020 to the controller of busway 1010. The controller of rack 1020 may implement a budget constraint assigned to rack 1020 and/or an enforcement threshold imposed on rack 1020 by imposing enforcement thresholds on the hosts included in rack 1020.

In an example embodiment, rack 1022 is a rack of hosts that includes one or more rPDUs configured to distribute electricity to the hosts in rack 1022. In other words, rack 1022 is a parent device to the hosts included in rack 1022. If rack 1022 includes multiple rPDUs, an rPDU in rack 1022 may be configured to serve as (a) a source of electricity for a subset of the hosts in the rack 1022 and (b) a backup source of electricity for another subset of the hosts in rack 1022. Rack 1022 is managed by a leaf-level controller spawned in the enforcement plane of the system. The controller of rack 1022 monitors the state of rack 1022, and the controller of rack 1022 reports the state of rack 1022 to the controller of busway 1010. The controller of rack 1022 may implement a budget constraint assigned to rack 1022 and/or an enforcement threshold imposed on rack 1022 by imposing enforcement thresholds on the hosts included in rack 1022.

In an example embodiment, rack 1024 is a rack of hosts that includes one or more rPDUs configured to distribute electricity to the hosts in rack 1024. In other words, rack 1024 is a parent device to the hosts included in rack 1024. If rack 1024 includes multiple rPDUs, an rPDU in rack 1024 may be configured to serve as (a) a source of electricity for a subset of the hosts in the rack 1024 and (b) a backup source of electricity for another subset of the hosts in rack 1024. Rack 1024 is managed by a leaf-level controller spawned in the enforcement plane of the system. The controller of rack 1024 monitors the state of rack 1024, and the controller of rack 1024 reports the state of rack 1024 to the controller of busway 1012. The controller of rack 1024 may implement a budget constraint assigned to rack 1024 and/or an enforcement threshold imposed on rack 1024 by imposing enforcement thresholds on the hosts included in rack 1024.

In an example embodiment, rack 1026 is a rack of hosts that includes one or more rPDUs configured to distribute electricity to the hosts in rack 1026. In other words, rack 1026 is a parent device to the hosts included in rack 1026. If rack 1026 includes multiple rPDUs, an rPDU in rack 1026 may be configured to serve as (a) a source of electricity for a subset of the hosts in the rack 1026 and (b) a backup source of electricity for another subset of the hosts in rack 1026. Rack 1026 is managed by a leaf-level controller spawned in the enforcement plane of the system. The controller of rack 1026 monitors the state of rack 1026, and the controller of rack 1026 reports the state of rack 1026 to the controller of busway 1012. The controller of rack 1026 may implement a budget constraint assigned to rack 1026 and/or an enforcement threshold imposed on rack 1026 by imposing enforcement thresholds on the hosts included in rack 1026.

In an example embodiment, rack 1028 is a rack of hosts that includes one or more rPDUs configured to distribute electricity to the hosts in rack 1028. In other words, rack 1028 is a parent device to the hosts included in rack 1028. If rack 1028 includes multiple rPDUs, an rPDU in rack 1028 may be configured to serve as (a) a source of electricity for a subset of the hosts in the rack 1028 and (b) a backup source of electricity for another subset of the hosts in rack 1028. Rack 1028 is managed by a leaf-level controller spawned in the enforcement plane of the system. The controller of rack 1028 monitors the state of rack 1028, and the controller of rack 1028 reports the state of rack 1028 to the controller of busway 1014. The controller of rack 1028 may implement a budget constraint assigned to rack 1028 and/or an enforcement threshold imposed on rack 1028 by imposing enforcement thresholds on the hosts included in rack 1028.

In an example embodiment, rack 1030 is a rack of hosts that includes one or more rPDUs configured to distribute electricity to the hosts in rack 1030. In other words, rack 1030 is a parent device to the hosts included in rack 1030. If rack 1030 includes multiple rPDUs, an rPDU in rack 1030 may be configured to serve as (a) a source of electricity for a subset of the hosts in the rack 1030 and (b) a backup source of electricity for another subset of the hosts in rack 1030. Rack 1030 is managed by a leaf-level controller spawned in the enforcement plane of the system. The controller of rack 1030 monitors the state of rack 1030, and the controller of rack 1030 reports the state of rack 1030 to the controller of busway 1014. The controller of rack 1030 may implement a budget constraint assigned to rack 1030 and/or an enforcement threshold imposed on rack 1030 by imposing enforcement thresholds on the hosts included in rack 1030.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application, in the specific form in which such claims issue, including any subsequent correction.

What is claimed is:

1. A method comprising:
monitoring operating conditions of a data center, the data center comprising a plurality of devices that are represented in a topology of the data center;
based, at least in part, on monitoring the operating conditions of the data center, determining and/or predicting a set of one or more changes to the data center, the set of one or more changes to the data center comprising an actual or predicted change to at least one of:
(a) a topological characteristic of the data center,
(b) a characteristic of a physical device comprised within the data center,
(c) an external limitation imposed on the data center,
(d) an internal atmospheric condition of the data center,
(e) an external atmospheric condition of the data center, or
(f) power drawn by one or more devices comprised within the data center that are not represented in the topology of the data center; and
responsive to determining the set of one or more changes to the data center:
generating updated budgeting for the data center, wherein the updated budgeting for the data center comprises one or more updated budgets respectively assigned to one or more devices of the plurality of devices that are represented in the topology of the data center;
wherein the method is performed by at least one device including a hardware processor.

2. The method of claim 1:
wherein the plurality of devices are represented within the topology of the data center by a respective plurality of elements arranged in a hierarchy of parent-child relationships;
wherein the hierarchy of parent-child relationships corresponds to at least part of an electricity distribution network of the data center;
wherein the updated budgeting for the data center comprises a plurality of budgets that are respectively assigned to the plurality of devices; and
wherein the plurality of budgets comprises the one or more updated budgets.

3. The method of claim 1:
wherein generating the updated budgeting for the data center comprises generating a particular budget for a particular device comprised within the data center based, at least in part, on (a) a first budget for a parent device of the particular device and/or (b) a second budget for a child device of the particular device; and
wherein the updated budgeting for the data center further comprises the first budget and the second budget.

4. The method of claim 1:
wherein determining and/or predicting the set of one or more changes to the data center comprises determining and/or predicting a change to the topological characteristic of the data center; and
wherein determining and/or predicting the change to the topological characteristic of the data center comprises at least one of:
(a) detecting a presence of a first device that was previously not detected in the data center,
(b) detecting an absence of a second device that was previously detected in the data center, or
(c) detecting an alteration to how electricity is distributed to a child device comprised within the data center.

5. The method of claim 4, further comprising:
generating an updated topology of the data center, wherein the updated topology of the data center indicates at least one of:
(a) the presence of the first device that was previously not detected in the data center,
(b) the absence of the second device that was previously detected in the data center, or
(c) the alteration to how electricity is distributed to the child device comprised within the data center;
wherein generating the updated budgeting for the data center is based, at least in part, on the updated topology of the data center.

6. The method of claim 1:
wherein determining and/or predicting the set of one or more changes to the data center comprises determining and/or predicting a change to the characteristic of the physical device;
wherein determining and/or predicting the change to the characteristic of the physical device comprises at least one of:
(a) detecting a complete or partial failure of the physical device,
(b) predicting the complete or partial failure of the physical device,
(c) detecting an increase in a temperature of the physical device, or
(d) detecting a reduced operational capacity of the physical device; and
wherein the physical device is a compute device, a power infrastructure device, or an atmospheric regulation device.

7. The method of claim 1:
wherein determining and/or predicting the set of one or more changes to the data center comprises determining and/or predicting a change to the characteristic of the physical device;
wherein the physical device is an atmospheric regulation device of data center;
wherein the change to the characteristic of the physical device is a failure of the atmospheric regulation device or a partial failure of the atmospheric regulation device;
wherein the one or more updated budgets comprises a budget for a particular device comprised within an environment of the data center that is intended to be regulated by the atmospheric regulation device; and
wherein the particular device is a power infrastructure device or a compute device.

8. The method of claim 1:
wherein determining and/or predicting the set of one or more changes to the data center comprises determining and/or predicting a change to the external limitation imposed on the data center; and
wherein the external limitation is (a) a regulation imposed on the data center, (b) an available supply of electricity that can be supplied to the data center, or (c) a cost of electricity that can be supplied to the data center.

9. The method of claim 1:
wherein determining and/or predicting the set of one or more changes to the data center comprises at least one of:
(a) determining and/or predicting a first change to the internal atmospheric condition of the data center, or
(b) determining and/or predicting a second change to the external atmospheric condition of the data center;
wherein the first change to the internal atmospheric condition is a first increase in an internal temperature of the data center;
wherein the second change to the external atmospheric condition of the data center is a second increase in an external temperature of the data center; and
wherein enforcing the one or more updated budgets causes a reduction in the internal temperature of the data center.

10. The method of claim 1:
wherein determining and/or predicting the set of one or more changes to the data center comprises predicting a change to the internal atmospheric condition of the data center;
wherein predicting the change to the internal atmospheric condition of the data center comprises: predicting an increase in an internal temperature of the data center based on at least one of: (a) detecting a rise in an external temperature of the data center, (b) detecting a failure or partial failure of an atmospheric regulation device of the data center, or (c) a forecasted atmospheric condition in a geographical region comprising the data center; and
wherein the one or more updated budgets reduce temperatures of devices comprised within the data center.

11. The method of claim 1, wherein generating the updated budgeting for the data center comprises:
training a machine learning model to generate budgets for devices in the data center with sets of training data, wherein a set of training data of the sets of training data defines an association between a set of operating conditions of a particular data center and a particular budgeting for the particular data center;
applying the machine learning model to generate the updated budgeting for the data center based, at least in part, on the operating conditions of the data center;
obtaining feedback regarding the updated budgeting; and
further training the machine learning model based on the feedback.

12. One or more non-transitory computer-readable media comprising instructions that, when executed by one or more hardware processors, cause performance of operations comprising:
monitoring operating conditions of a data center, the data center comprising a plurality of devices that are represented in a topology of the data center;
based, at least in part, on monitoring the operating conditions of the data center, determining and/or predicting a set of one or more changes to the data center, the set of one or more changes to the data center comprising an actual or predicted change to at least one of:
(a) a topological characteristic of the data center,
(b) a characteristic of a physical device comprised within the data center,
(c) an external limitation imposed on the data center,
(d) an internal atmospheric condition of the data center,
(e) an external atmospheric condition of the data center, or
(f) power drawn by one or more devices not represented in the topology of the data center; and
responsive to determining the set of one or more changes to the data center:
generating updated budgeting for the data center, wherein the updated budgeting for the data center comprises one or more updated budgets respectively assigned to one or more devices of the plurality of devices that are represented in the topology of the data center.

13. The one or more non-transitory computer-readable media of claim 12:
wherein the plurality of devices are represented within the topology of the data center by a respective plurality of elements arranged in a hierarchy of parent-child relationships;
wherein the hierarchy of parent-child relationships corresponds to at least part of an electricity distribution network of the data center;
wherein the updated budgeting for the data center comprises a plurality of budgets that are respectively assigned to the plurality of devices; and
wherein the plurality of budgets comprises the one or more updated budgets.

14. The one or more non-transitory computer-readable media of claim 12:
wherein generating the updated budgeting for the data center comprises generating a particular budget for a particular device comprised within the data center based, at least in part, on (a) a first budget for a parent device of the particular device and/or (b) a second budget for a child device of the particular device; and
wherein the updated budgeting for the data center further comprises the first budget and the second budget.

15. The one or more non-transitory computer-readable media of claim 12:
wherein determining and/or predicting the set of one or more changes to the data center comprises determining and/or predicting a change to the topological characteristic of the data center; and
wherein determining and/or predicting the change to the topological characteristic of the data center comprises at least one of:
(a) detecting a presence of a first device that was previously not detected in the data center,
(b) detecting an absence of a second device that was previously detected in the data center, or
(c) detecting an alteration to how electricity is distributed to a child device comprised within data center.

16. The one or more non-transitory computer-readable media of claim 15, further comprising:
generating an updated topology of the data center, wherein the updated topology of the data center indicates at least one of:
(a) the presence of the first device that was previously not detected in the data center,
(b) the absence of the second device that was previously detected in the data center, or
(c) the alternation to how electricity is distributed to the child device comprised within the data center; and
wherein generating the updated budgeting for the data center is based, at least in part, on the updated topology of the data center.

17. The one or more non-transitory computer-readable media of claim 12:
wherein determining and/or predicting the set of one or more changes to the data center comprises determining and/or predicting a change to the characteristic of the physical device;
wherein determining and/or predicting the change to the characteristic of the physical device comprises at least one of:
(a) detecting a complete or partial failure of the physical device,
(b) predicting the complete or partial failure of the physical device,
(c) detecting an increase in a temperature of the physical device, or
(d) detecting a reduced operational capacity of the physical device; and
wherein the physical device is a compute device, a power infrastructure device, or an atmospheric regulation device.

18. The one or more non-transitory computer-readable media of claim 12:
wherein determining and/or predicting the set of one or more changes to the data center comprises determining and/or predicting a change to the characteristic of the physical device;
wherein the physical device is an atmospheric regulation device of the data center;
wherein the change to the characteristic of the physical device is a failure of the atmospheric regulation device or a partial failure of the atmospheric regulation device;
wherein the one or more updated budgets comprises a budget for a particular device comprised within an environment of the data center that is intended to be regulated by the atmospheric regulation device; and
wherein the particular device is a power infrastructure device or a compute device.

19. The one or more non-transitory computer-readable media of claim 12:
wherein determining and/or predicting the set of one or more changes to the data center comprises at least one of:
(a) determining and/or predicting a first change to the internal atmospheric condition of the data center, or
(b) determining and/or predicting a second change to the external atmospheric condition of the data center;
wherein the first change to the internal atmospheric condition is a first increase in an internal temperature of the data center;
wherein the second change to the external atmospheric condition of the data center is a second increase in an external temperature of the data center; and
wherein enforcing the one or more updated budgets causes a reduction in the internal temperature of the data center.

20. A system comprising:
at least one device including a hardware processor;
the system being configured to perform operations comprising:
monitoring operating conditions of a data center, the data center comprising a plurality of devices that are represented in a topology of the data center;
based, at least in part, on monitoring the operating conditions of the data center, determining and/or predicting a set of one or more changes to the data center, the set of one or more changes to the data center comprising an actual or predicted change to at least one of:
(a) a topological characteristic of the data center,
(b) a characteristic of a physical device comprised within the data center,
(c) an external limitation imposed on the data center,
(d) an internal atmospheric condition of the data center,
(e) an external atmospheric condition of the data center, or
(f) power drawn by one or more devices not represented in the topology of the data center; and
responsive to determining the set of one or more changes to the data center:
generating updated budgeting for the data center, wherein the updated budgeting for the data center comprises one or more updated budgets respectively assigned to one or more devices of the plurality of devices that are represented in the topology of the data center.
